(19) United States
(12) Patent Application Publication
(10) Pub. No.: US 2018/0316540 A1
(43) Pub. Date: Nov. 1, 2018

(54) RECEIVE-SIDE NONLINEAR POWER AMPLIFIER DISTORTION CANCELLATION

(71) Applicant: Avago Technologies General IP (Singapore) Pte. Ltd., Singapore (SG)

(72) Inventor: Ba-Zhong SHEN, Irvine, CA (US)

(73) Assignee: Avago Technologies General IP (Singapore) Pte. Ltd., Singapore (SG)

(21) Appl. No.: 15/961,690

(22) Filed: Apr. 24, 2018

Related U.S. Application Data
(60) Provisional application No. 62/491,028, filed on Apr. 27, 2017.
(60) Provisional application No. 62/491,085, filed on Apr. 27, 2017.

(51) Int. Cl. H04L 27/26; H04L 5/00

(52) U.S. Cl. CPC H04L 27/2688; H04L 5/0007; H04L 27/265

(57) ABSTRACT

In some aspects, the disclosure is directed to methods and systems for receive-side distortion cancellation in orthogonal frequency division multiplexing (OFDM). Each of a plurality of OFDM receivers generates a distortion signal; modulates, amplifies, and demodulates the distortion signal; and then mixes a received signal with an inverse of the demodulated distortion signal, along with demodulated distortion signals provided by each other receiver. The resulting output signal may be de-mapped and decoded, with amplifier distortion reduced.

### RELATED APPLICATIONS

The present application claims the benefit of and priority to U.S. Provisional Patent Application Nos. 62/491,028 and 62/491,085, both entitled “Receive-Side Nonlinear Power Amplifier Distortion Cancellation” and filed Apr. 27, 2017, the entireties of which are incorporated by reference herein.

### FIELD OF THE DISCLOSURE

This disclosure generally relates to systems and methods for non-linear distortion cancellation. In particular, this disclosure relates to systems and methods for receive-side non-linear power amplifier distortion cancellation for orthogonal frequency division multiple access (OFDMA) systems.

### BACKGROUND OF THE DISCLOSURE

Orthogonal frequency division multiple access (OFDMA) systems provide high data rates to multiple wireless clients via orthogonal frequency division multiplexing (OFDM). Multiple subcarriers on orthogonal, non-interfering frequencies are used to transmit data symbols in parallel, increasing signal to noise ratios at the receiver. For multiple access, in some implementations, subcarriers may be allocated to a user equipment (UE) for a number of OFDM symbol periods, avoiding interference with other UEs. In some implementations, all subcarriers may be allocated to a single device, while in other implementations, subcarriers may be distributed among devices, or among transmitting and receiving devices (e.g. uplink and downlink transmissions). By distributing symbol transmissions of any device over many symbol periods and multiple subcarriers, interference from burst wideband noise may be reduced or eliminated.

In today's wireline and wireless communication systems, various techniques have been proposed to reduce distortions on communication channels. There are some distortions caused by hardware impairments when the communication channel is hit by nonlinearity, which degrades the bit error rate performance. The nonlinearity is mostly generated by analog and radio frequency devices. The nonlinear devices includes various communication devices such as solid-state devices in radio frequency transmission/reception, high power amplifiers (PA) and low noise amplifiers. The nonlinear devices can receive instantaneous input signals. The nonlinearity appears when the instantaneous input signal power fluctuates and approaches the saturation level of the device.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1A is a block diagram of an embodiment of an environment for an orthogonal frequency division multiple access (OFDMA) system;

FIG. 1B is a block diagram of an embodiment of a portion of an OFDM with low density parity check (LDPC) transmission and reception system;

FIG. 1C is a diagram of an embodiment of a modulation process for a communication system;

FIG. 1D is a diagram of an embodiment of a demodulation process for a communication system;

FIG. 2A is a diagram of an embodiment of an OFDMA frame, according to one implementation;

FIG. 2B is a block diagram of an embodiment of a portion of an OFDMA transmission and reception system;

FIG. 2C is a graph illustrating potential interference between modulated subcarriers in an OFDMA system, according to some implementations;

FIG. 2D is a diagram illustrating a turbo distortion cancellation (TNC) method for an OFDM system according to an embodiment;

FIG. 3A is a block diagram of an implementation of an OFDMA receiver incorporating a turbo distortion cancellation (TDC) system;

FIG. 3B is a block diagram of an implementation of a portion of an OFDMA-TDC receiver;

FIG. 3C is a flow chart of an implementation of a method for turbo distortion cancellation in an OFDMA-TDC receiver;

FIG. 4A is an illustration of a modulation scheme used to test an example embodiment of an OFDMA-TDC system;

FIG. 4B depicts graphs of performance of an implementation of a test of an OFDMA-TDC system;

FIG. 4C depicts a graph of performance of an implementation of a test of an OFDM-TDC system;

FIG. 4D depicts a graph of performance of an implementation of a test of an TDC system;

FIG. 5A is a block diagram depicting an embodiment of a network environment including one or more access points in communication with one or more devices or stations; and

FIGS. 5B and 5C are block diagrams depicting embodiments of computing devices useful in connection with the methods and systems described herein.

The patent or application file contains at least one drawing executed in color. Copies of this patent or patent application publication with color drawing(s) will be provided by the Office upon request and payment of the necessary fee.

The details of various embodiments of the methods and systems are set forth in the accompanying drawings and the description below.

### DETAILED DESCRIPTION

The following IEEE standard(s), including any draft versions of such standard(s), are hereby incorporated herein by reference in their entirety and are made part of the present disclosure for all purposes: IEEE P802.11n™; and IEEE P802.11ac™. Although this disclosure may reference aspects of these standard(s), the disclosure is in no way limited by these standard(s).

For purposes of reading the description of the various embodiments below, the following descriptions of the sections of the specification and their respective contents may be helpful:
Section A describes embodiments of systems and methods for orthogonal frequency division-multiple access (OFDMA) and turbo distortion cancellation (TDC); and
Section B describes a network environment and computing environment which may be useful for practicing embodiments described herein.

### A. Turbo Distortion Cancellation (TDC) for OFDMA

Orthogonal frequency division multiple access (OFDMA) systems provide high data rates to multiple wireless clients via orthogonal frequency division multiplexing (OFDM). Multiple subcarriers on orthogonal, non-interfering frequencies are used to transmit data symbols in parallel, increasing signal to noise ratios at the receiver. For multiple access, in some implementations, subcarriers may be allocated to a user equipment (UE) for a number of OFDM symbol periods, avoiding interference with other UEs. In some implementations, all subcarriers may be allocated to a single device, while in other implementations, subcarriers may be distributed among devices, or among transmitting and receiving devices (e.g. uplink and downlink transmissions). By distributing symbol transmissions of any device over many symbol periods and multiple subcarriers, interference from burst wideband noise may be reduced or eliminated.

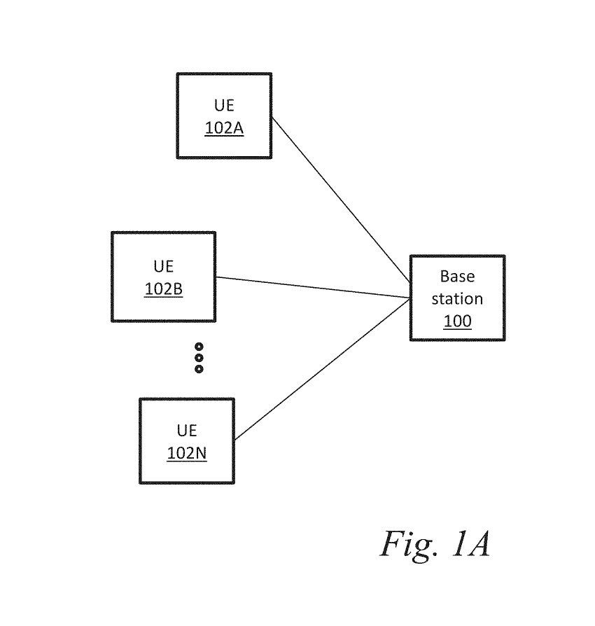

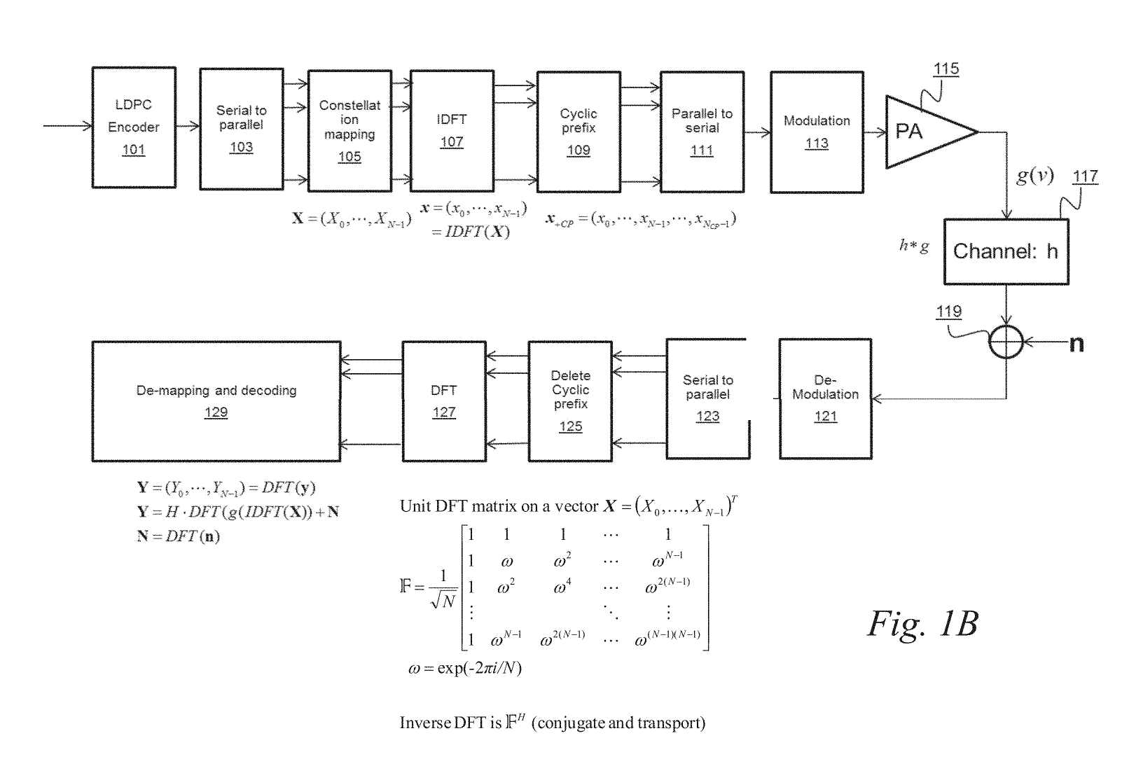

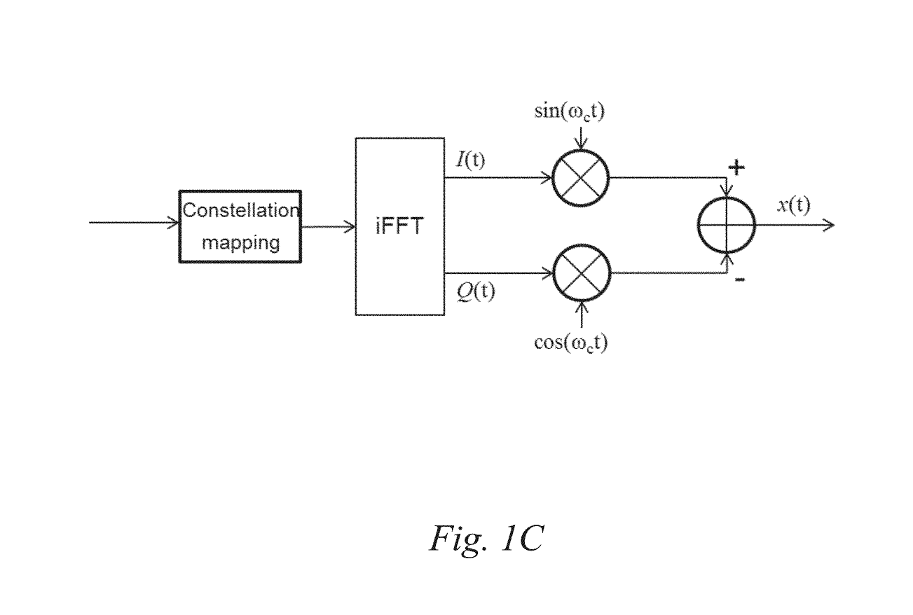

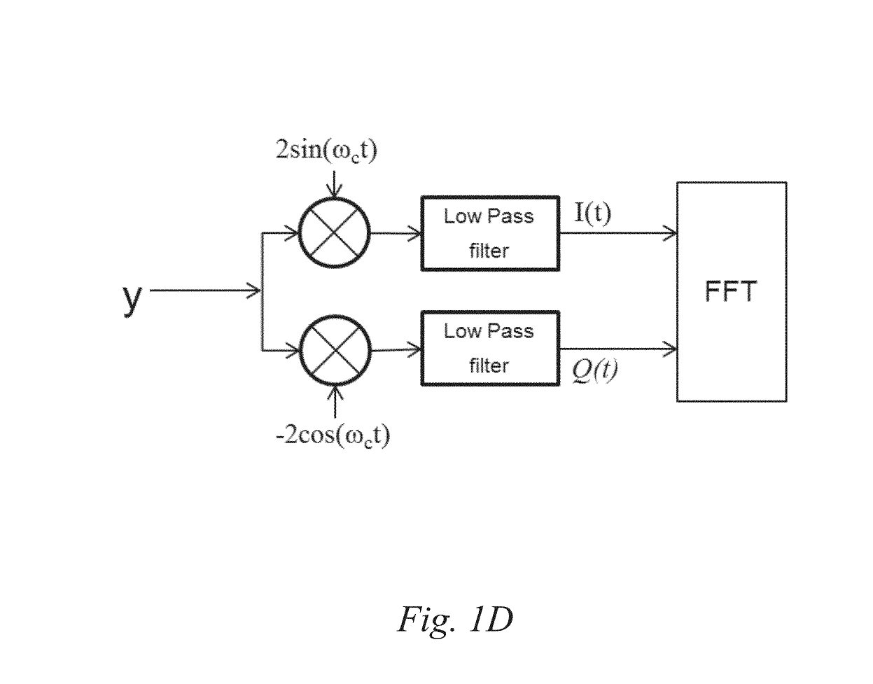

FIG. 1 is a block diagram of an embodiment of an environment for an orthogonal frequency division multiple access (OFDMA) system. As shown, one or more user equipment (UE) 102A-102N may communicate with one (or more) base stations 100 via a wireless communication interface. UE 102 may comprise any type and form of user equipment, including smart phones, tablet computers, laptop computers, wearable computers, appliance computing devices, home automation systems, or any other type and form of user computing device. Base station 100 may comprise any type and form of wireless access point, such as a WiFi access point or router, picocell, microcell, macrocell, or any other communication device. Base station 100 and UE 102A-102N may communicate via an OFDMA system, with communications distributed over time and a plurality of orthogonal subcarriers.

FIG. 1B is a block diagram of an embodiment of a portion of an OFDM with low density parity check (LDPC) transmission and reception system. A low density parity check (LDPC) encoder 101 may receive data to be transmitted, and may provide the data to a serial-to-parallel multiplexer 103, which may distribute the data across a plurality of outputs (corresponding to a plurality of subcarriers for transmission). An encoder or constellation mapper 105 may map the symbols to subcarriers (e.g. a quadrature amplitude modulation (QAM) encoder, phase-shift keying (PSK) encoder, etc.). For example, the OFDM symbols arranged in a matrix may be denoted as:

X=(X₀,Λ,X_{N-1})

The resulting amplitude and phase information may be provided to an inverse discrete Fourier transform (IDFT) 107 to convert to time-domain samples (e.g. xᵢ as the output of IDFT(Xᵢ), where i=0, 1, 2, 3). A cyclic prefix may be appended to the output between each block of samples at 109 to protect against interference between symbols. The multiple outputs from 109 are parallel data and are provided to a parallel-to-serial multiplexer 111, which converts the input parallel data to output serial data. The subcarrier may be modulated according to the converted serial data at 113 (e.g. modulating xᵢ to uᵢ) and provided to a power amplifier (PA) 115 and transmitted via the corresponding channel h 117 (e.g. power amplifier output gᵢ(uᵢ)=uᵢ+d(uᵢ) for i=0, 1, 2, 3).

The signal may be received by a receiver of a corresponding device, along with signals on other channels (corresponding to other receiver blocks or cable modems, not illustrated), summed at mixer 119 (resulting in r=g₀(u₀)+g₁(u₁)+g₂(u₂)+g₃(u₃)+ [symbol] for 1=0, 1, 2, 3, with [symbol] representing additive white Gaussian noise). The desired modulated subcarrier is further demodulated at 121 and provides multiple parallel outputs via a serial-to-parallel multiplexer 123. The cyclic prefix may be removed from each block at 125, and a discrete Fourier transform (DFT) 127 is calculated to extract the original constellation amplitude and phase values. The unit DFT matrix can be represented as:

$$Unit DFT matrix on a vector X = {( {X}_{0} , K , {X}_{N - 1} )}^{T}$$

$$= \frac{1}{\sqrt{N}} [ \begin{matrix}1 & 1 & 1 & Λ & 1 \\ 1 & ω & {ω}^{2} & Λ & {ω}^{N - 1} \\ 1 & {ω}^{2} & {ω}^{4} & Λ & {ω}^{2 ( N - 1 )} \\ M & & & O & M \\ 1 & {ω}^{N - 1} & {ω}^{2 ( N - 1 )} & Λ & {ω}^{( N - 1 ) ( N - 1 )}\end{matrix} ]$$

$$ω = exp ( - 2 π i / N )$$

$$Inverse DFT is {H}^{} ( conjugate and transport )$$

FIG. 1C illustrates a modulation process for a communication system. In some embodiments, the modulation process includes constellation mapping and inverse fast Fourier

s(t)=I(t)+jQt

transform (iFFT). An input signal x is provided for constellation mapping. After the mapping, the signal x can be represented as:

The constellation mapped signal s(t) is transformed using iFFT from frequency domain to time domain. After the iFFT, the modulated signal s(t) can be represented as:

x(t)=I(t)cos(ω_{c}t)−Q(t)sin(ω_{c}t)

FIG. 1D illustrates a demodulation process for a communication system. An input modulated signal y is input for demodulation. The signal y is separately multiplied by a sin factor 2 sin(ω_{c}t) and a con factor −2 cos(ω_{c}t). Each multiplied signal is processed by a low pass filter. The demodulation of y can represented as:

I(t)=2y(t)cos(ω_{c}t)

Q(t)=−2y(t)sin(ω_{c}t)

The demodulated signal is then demapped and decoded at 129, the decoded signal may be represented as:

Y=(Y₀,Λ,Y_{N-1})=DFT(y)

Y=H·DFT(g(IDFT(X))+N

N=DFT(n)

The power amplifier (PA) is used to increase the power of a signal. The PA can be a hardware device, software, or a combination of hardware and software. A theoretical response of a PA to instantaneous input is linear such that the inputs of the PA and the output of the PA are linearly correlated. However, because of the hardware impairments and/or input signal fluctuations, the output of the PA and the input of the PA are partially linearly correlated and partially non-linearly correlated. The PA can be modeled using various modeling methods, such as PA formula conversion after de-modulation, Soft Limiter (SL) model, Solid-state power amplifier (SSPA) model, Traveling-Wave Tube (TWT) model, polynomial models (e.g., 3^{rd} order harmonic PA model), etc.

According to some embodiments, a PA formula conversion after de-modulation can be used for modeling a PA with an input signal x and can be represented as:

Consider input: x=x_{R}+jx₁ with polar coordinates x=|x|e^{jϕ}

PA model: g(x)=F(ρ)e^{j(ϕ+Φ[ρ])},ρ=|x|
F(φ: AM/AM
Φ(φ: AM/PM

In the above, AM represents an amplitude modulation, and the PM represents a phase modulation.

According to some embodiments, the Soft Limiter (SL) PA model can be represented as:

$$g ( x ) = \{ \begin{matrix}x & ρ \leq A \\ A {e}^{j φ} & ρ > A\end{matrix} \\ A = \sqrt{{P}_{peak}}$$

For an input signal s, the modeling of the amplified signal s can be represented as:

$$s = {( {s}_{0} , Λ , {s}_{N - 1} )}^{T}$$

$$x = {( {x}_{0} , Λ , {x}_{N - 1} )}^{T} = IDFT ( s )$$

$$y = g ( x )$$

$$\overline{s} = DFT ( y ) ⇒ \\ \overline{s} = DFT ( Λ \cdot IDFT ( s ) ) = s + DFT ( g ( x ) - x ) = s + d$$

$$Λ = diag ( [ min ( \frac{A}{\vert {x}_{0} \vert} , 1 ) Λ , min ( \frac{A}{\vert {x}_{N - 1} \vert} , 1 ) ] )$$

According to some embodiments, the solid-state power amplifier (S SPA) model can be represented as:

$$g ( x ) = ( \frac{ρ}{{[ 1 + {( \frac{ρ}{A} )}^{2 p} ]}^{\frac{1}{2 p}}} ) {e}^{j φ}$$

According to some embodiments, the travelling-wave tube (TWT) model can be represented as:

$$g ( x ) = ( \frac{ρ}{1 + {( \frac{ρ}{2 A} )}^{2}} ) {e}^{( j φ + \frac{π}{3} \frac{{ρ}^{2}}{{ρ}^{2} + 4 {A}^{2}} )}$$

According to some embodiments, a polynomial PA modeling may be utilized. A nonlinear transfer function can be based upon the Taylor series expansion. For example, an input signal for a PA is Vin(t). The PA device model based on the Taylor serious expansion can be represented as:

vₒᵤₜ(t)=g(vᵢₙ(t))=a₁vᵢₙ(t)+a₂vᵢₙ²(t)+a₃vᵢₙ³(t)+Λ+a_{N}vᵢₙ^{N}(t)

In some embodiments, all terms with even order harmonic, such as a₂ₖvᵢₙ^{2k} (t) can be filtered out. In some embodiments, the terms with odd harmonic h>3 are small and can be neglected. Therefore, the nonlinear PA model can be simplified to a 3^{rd} order harmonic PA model, which can be represented as:

vₒᵤₜ(t)=gᵥvᵢₙ(t))=a₁vᵢₙ(t)+a₃vᵢₙ³(t)

In the above, vᵢₙ (t) represents the input power of the signal t, a₁ and a₃ are Taylor expansion parameters, vₒᵤₜ (t) represents the output power of signal t through the PA. In some embodiments, a₃ is set as a negative value (i.e., a₃<0) to represent a compress (saturation) phenomena.

In some embodiments, a signal x is modulated to s=x₁+jx_{Q}, the modulated signal s can be inputted to a PA model. The PA model can be represented generally using Bussgang's theorem as:

f_{NL}(x₁+jx_{Q})=(x₁+jx_{Q})+D(x₁+jx_{Q},f_{NL})

In the above, the term D(x₁+jx_{Q}, f_{NL}) is a function based on Bussgang's theorem. The nonlinearity of the PA results in receiver side distortions in the signals. In some embodiments, it is assumed that the receiver side knows what PA models was used to process the signals.

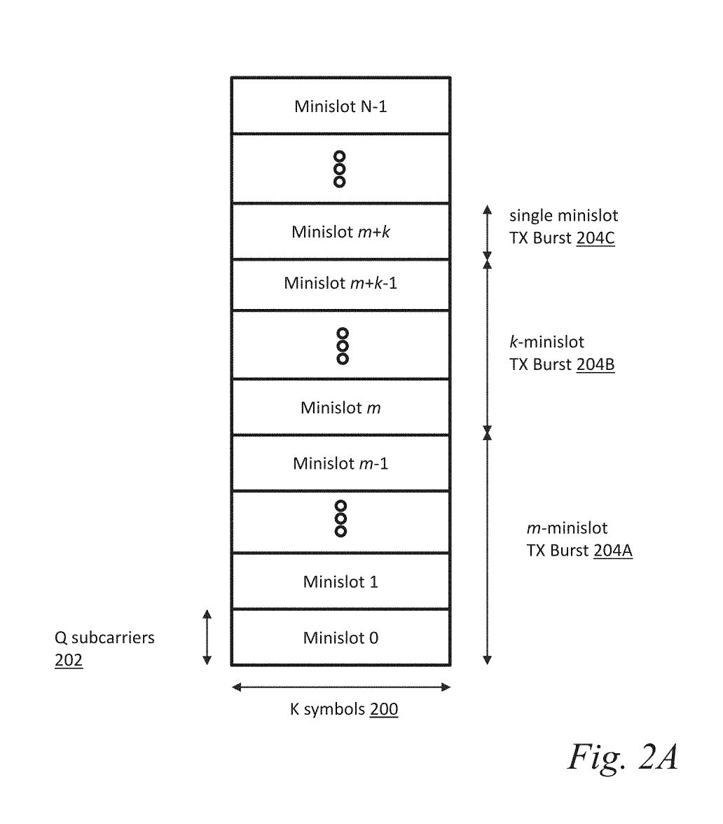

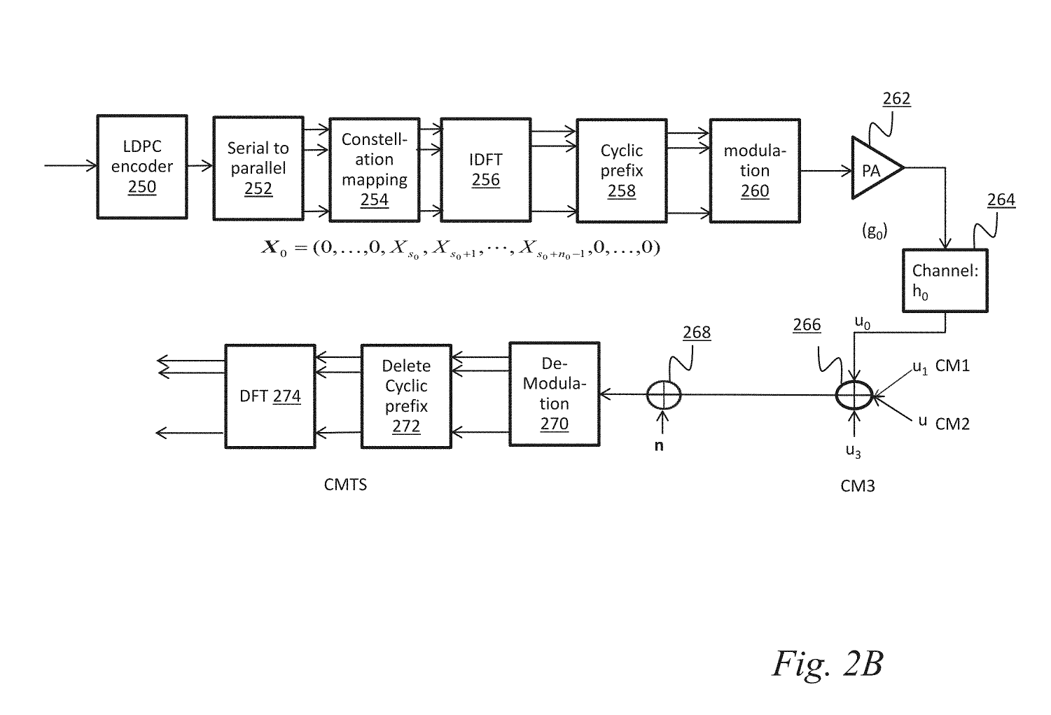

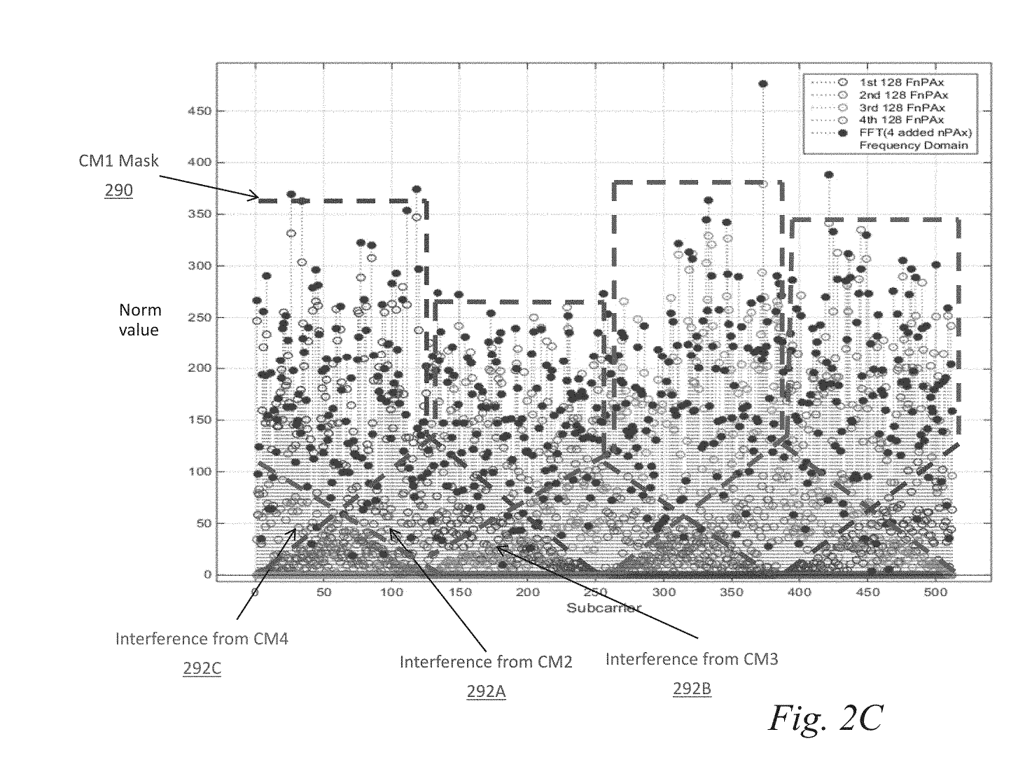

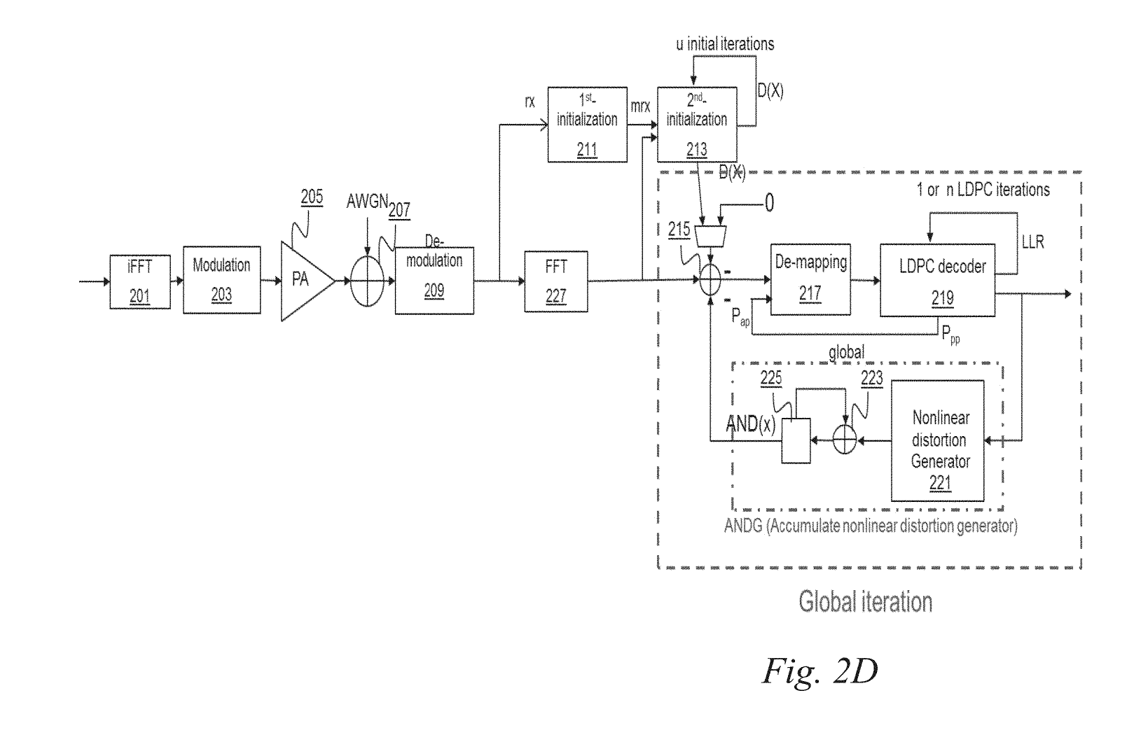

FIG. 2A is a diagram of an embodiment of an OFDMA frame, according to one implementation. The frame may be divided into a plurality of minislots, which may be allocated individually (e.g. single minislot TX burst 204C), or in groups (e.g. m-minislot TX burst 204A, k-minislot TX burst 204B). Each minislot may allow transmission (or receipt) of K symbols (200), via a plurality Q of subcarriers 202. As discussed above, minislots may be distributed both in frequency and time, such that a device may distribute symbols across a plurality of subcarriers over a predetermined time period.

FIG. 2B is a block diagram of an embodiment of a portion of an OFDMA transmission and reception system. A low density parity check (LDPC) encoder 250 may receive data to be transmitted, and may provide the data to a serial-to-parallel multiplexer 252, which may distribute the data across a plurality of outputs (corresponding to a plurality of subcarriers for transmission). An encoder or constellation mapper 254 may map the symbols to subcarriers (e.g. a quadrature amplitude modulation (QAM) encoder, phase-shift keying (PSK) encoder, etc.). For example, the OFDM symbols for a channel CMi Xᵢ with N subcarriers may be denoted as:

X₀=(0, . . . 0,X_{0,s}_{₀},X_{0,s}_{₀}₊₁, . . . ,X_{0,s}_{₀}₊ₙ_{₀}₋₁,0, . . . 0)

X₁=(0, . . . 0,X_{1,s}_{₁},X_{1,s}_{₁}₊₁, . . . ,X_{1,s}_{₁}₊ₙ_{₁}₋₁,0, . . . 0)

X₂=(0, . . . 0,X_{2,s}_{₂},X_{2,s}_{₂}₊₁, . . . ,X_{2,s}_{₂}₊ₙ_{₂}₋₁,0, . . . 0)

X₃=(0, . . . 0,X_{3,s}_{₃},X_{3,s}_{₃}₊₁, . . . ,X_{3,s}_{₃}₊ₙ_{₃}₋₁,0, . . . 0)
where {sᵢ, sᵢ+1, . . . , sᵢ+nᵢ−1}∩{sⱼ, sⱼ+1, . . . , sⱼ+nⱼ−1}=ϕ when i≠j

The resulting amplitude and phase information may be provided to an inverse discrete Fourier transform (IDFT) 256 to convert to time-domain samples (e.g. xᵢ as the output of IDFT(X₁), where i=0, 1, 2, 3). A cyclic prefix may be appended to the output between each block of samples at 258 to protect against interference between symbols. The subcarrier may be modulated according to the input stream at 260 (e.g. modulating xᵢ to uᵢ) and provided to a power amplifier 262 and transmitted via the corresponding channel 264 (e.g. power amplifier output gᵢ(uᵢ)=uᵢ+d(uᵢ) for i=0, 1, 2, 3).

The signal may be received by a receiver of a corresponding device, along with signals on other channels (corresponding to other receiver blocks or cable modems (e.g. CM1-CM3), not illustrated), summed at mixer 266 (resulting in r=g₀(u₀)+g₁(u₁)+g₂(u₂)+g₃(u₃)+ [symbol] for 1=0, 1, 2, 3, with [symbol] representing additive white Gaussian noise). The desired modulated subcarrier may be extracted at mixer 268 and demodulated at 270. The cyclic prefix may be removed from each block at 272, and a discrete Fourier transform 274 calculated to extract the original constellation amplitude and phase values. The de-modulated signal, for the four channel implementation shown, may be represented as y=g̅₀(u₀)+g̅₁(u₁)+g̅₂(u₂)+ĝ₃(u₃)+Ñ.

FIG. 2C is a graph illustrating potential interference between modulated subcarriers in an OFDMA system, according to some implementations. As discussed above and as shown, modulated subcarriers may have overlapping areas of interference. For example, a signal mask 290 for a first modem CM1 may be intruded into by interference from CM2 292A, CM3 292B, and CM4 292C, as the spacing between subcarriers may be too narrow for complete isolation.

Given a vector V=(V₀, V₁, . . . , V_{N-1}), with N being the OFDM symbol size:

$$V {\vert}_{{s}_{i} , {s}_{i} + 1 , … , {s}_{i} + {n}_{i} - 1} = ( 0 , … 0 , {V}_{{s}_{i}} , {V}_{{s}_{i} + 1} , … , {V}_{{s}_{i} + {n}_{i} - 1} , 0 , … , 0 )$$

$$After demodulation \text{:} y = {\overline{g}}_{0} ( {x}_{0} ) + {\overline{g}}_{1} ( {x}_{1} ) + {\overline{g}}_{2} ( {x}_{2} ) + {\overline{g}}_{3} ( {x}_{3} ) + \\ ⇒ \\ \begin{matrix}R = DFT ( y ) \\ = DFT ( {\overline{g}}_{0} ( {x}_{0} ) + {\overline{g}}_{1} ( {x}_{1} ) + {\overline{g}}_{2} ( {x}_{2} ) + {\overline{g}}_{3} ( {x}_{3} ) + ) \\ = DFT ( {\overline{g}}_{0} ( {x}_{0} ) ) + DFT ( {\overline{g}}_{1} ( {x}_{1} ) ) + DFT ( {\overline{g}}_{2} ( {x}_{2} ) ) + \\ DFT ( {\overline{g}}_{3} ( {x}_{3} ) ) + \\ = {X}_{0} + D ( {X}_{0} , {\overline{g}}_{0} ) + {X}_{1} + D ( {X}_{1} , {\overline{g}}_{1} ) + {X}_{2} + D ( {X}_{2} , {\overline{g}}_{2} ) + {X}_{3} + \\ D ( {X}_{3} , {\overline{g}}_{3} ) +\end{matrix} \\ ⇒ \\ \begin{matrix}{R}_{i} = R {\vert}_{{s}_{i} , {s}_{i} + 1 , … , {s}_{i} + {n}_{i} - 1} \\ = {X}_{i} + D ( {X}_{0} , {\overline{g}}_{0} ) {\vert}_{{s}_{i} , {s}_{i} + 1 , … , {s}_{i} + {n}_{i} - 1} + D ( {X}_{1} , {\overline{g}}_{1} ) {\vert}_{{s}_{i} , {s}_{i} + 1 , … , {s}_{i} + {n}_{i} - 1} + \\ D ( {X}_{2} , {\overline{g}}_{2} ) {\vert}_{{s}_{i} , {s}_{i} + 1 , … , {s}_{i} + {n}_{i} - 1} + D ( {X}_{3} , {\overline{g}}_{3} ) {\vert}_{{s}_{i} , {s}_{i} + 1 , … , {s}_{i} + {n}_{i} - 1} + \\ {\vert}_{{s}_{i} , {s}_{i} + 1 , … , {s}_{i} + {n}_{i} - 1}\end{matrix}$$

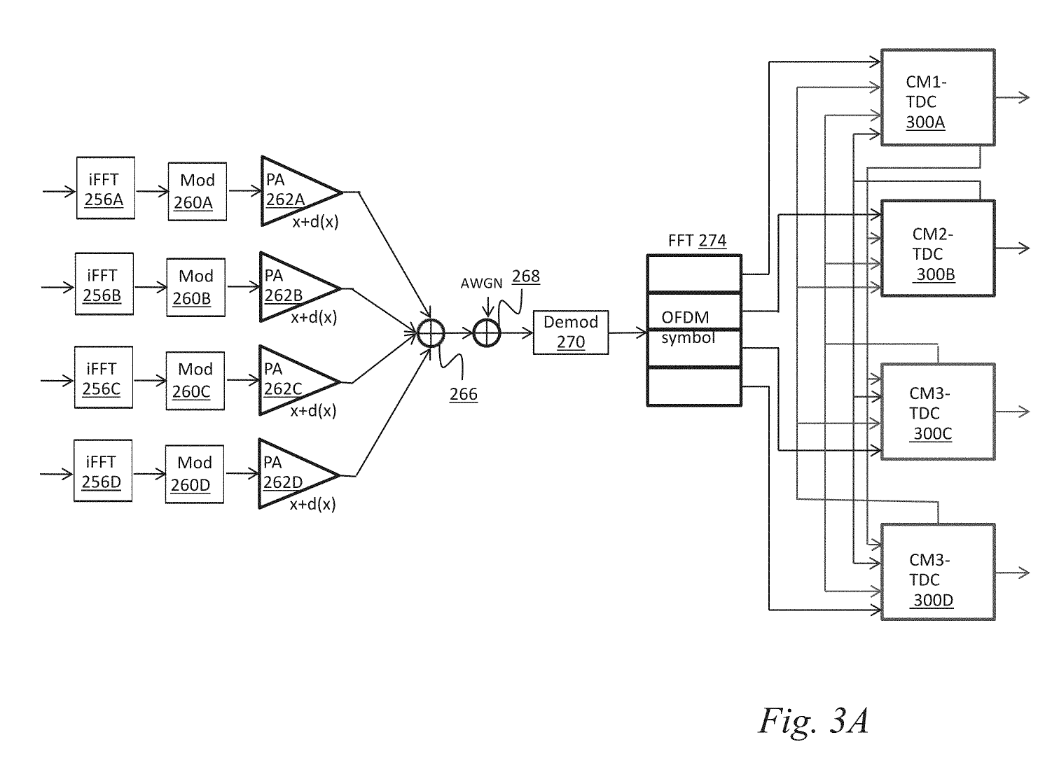

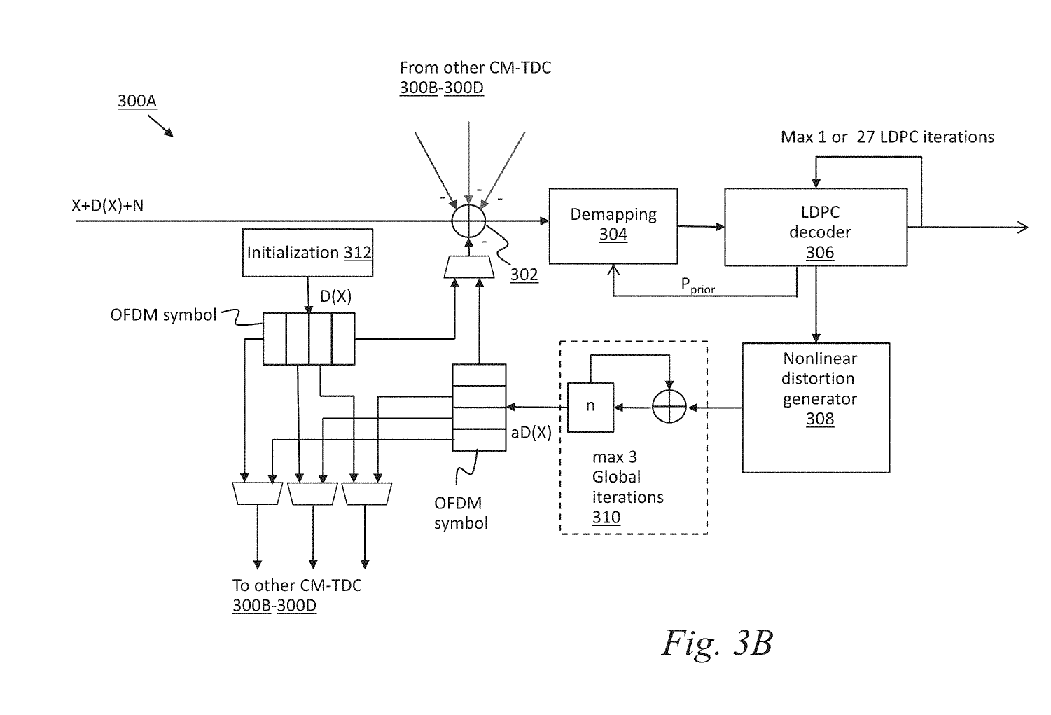

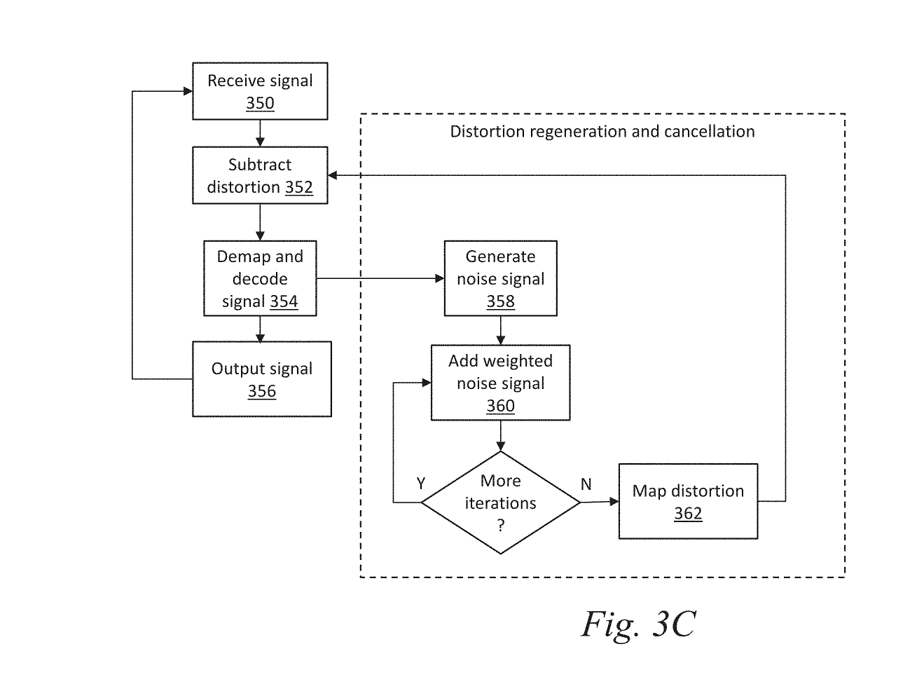

In some implementations, distortion may be canceled by iteratively providing demodulation products between modems for different channels. For example, referring now to FIG. 3A, illustrated is a block diagram of an implementation of an OFDMA receiver incorporating a turbo distortion cancellation (TDC) system. In the example illustrated, four transmitter and receiver modems are shown; however, in other implementations, additional channels or modems may be utilized. As discussed above, transmitters may include inverse Fourier transformers 256A-256D (e.g. iDFT or iFFTs), modulators 260A-260D, and amplifiers 262A-262D. Although not shown, in many implementations, cyclic prefixes may be added prior to modulation. The channels may be mixed via mixer 266, which may be part of the transmission system or receiver system (e.g. at the antenna) or may be mixed electromagnetically during broadcast. Accordingly, mixer 266 may be a discrete component, or may be a physical result. Similarly, the mixing of the modulated signal with additive white Gaussian noise at 268 may be via a mixing circuit, such as in a test environment, or may be mixed physically during broadcast and/or reception. The received signal may be demodulated at 270, and provided to a Fourier transformer 272 (e.g. DFT or FFT) to recover the OMDF symbols. In some implementations, a cyclic prefix may be removed after demodulation.

The symbols may be provided to turbo distortion cancellers (TDC) 300A-300D as shown, with each canceller receiving an input symbol and output of the other cancellers 300. Referring now to FIG. 3B, illustrated is a block diagram of an implementation of a canceller 300A of an OFDMA-TDC receiver performing distortion cancellation. An input signal comprising noise may be mixed at 302 with inverted signals from other cancellers 300B-300D, along with a negative feedback path from within the canceller (e.g. said signals may be subtracted from the input signal). The result may be demapped at 304 and provided to LDPC decoder 306 to recover the original bitstream. Demapping may utilized feedback of prior parity signals from LDPC decoder 306. Additionally, in some implementations, LDPC decoder may operate in single or multiple iterations.

To provide negative feedback of distortion for the channel (and for other cancellers), the output signal from LDPC decoder 306 may be provided to a nonlinear distortion generator 308. The output distortion signal may, in some implementations, be mixed with itself for a number of iterations at iterative feedback mixer 310 (e.g., comprising a counter and mixer). The summed and mixed noise may be mapped to OFDM symbols, resulting in a symbol-mapped representation of noise. This noise may be subtracted from the input signal at 302 as discussed above, as well as provided to other cancellers 300B-300D as shown. Additionally, for initialization 312, a predetermined signal D(X) may be generated as follows:

Intitialize CMi Xᵢ to

1) Xᵢ=(0, . . . 0, X_{i,s}_{ᵢ}, X_{i,s}_{ᵢ}₊₁, . . . , X_{i,s}_{ᵢ}₊ₙ_{ᵢ}₋₁, 0, . . . 0)
where X_{i,s}_{ᵢ}₊ⱼ=constellation_map(0), j=0, . . . , nᵢ−1

2) Compute xᵢ=IDFT(Xᵢ);

3) Compute and output D(Xᵢ, gᵢ)=DFT(gᵢ(xᵢ)−xᵢ)

Accordingly, the cancellation algorithm provides an iterative generation of a distortion signal that may be distributed to other modems and subtracted from an incoming signal to cancel distortion. Specifically, in each canceller 300:

Let : m = 0 and D̅ᵢ^{(m)} = l_{i,I}_{ᵢ}D(Xᵢ^{(I}^{ᵢ}⁾, gᵢ), i = 0, 1, 2, 3,
where D(Xᵢ^{(I}^{ᵢ}⁾, gᵢ) is obtained from initialization

| | |
|---|---|
| 1) | $\begin{matrix}For i = 0 , 1 , 2 , 3 using {R}_{i} = R {\text{\textbar}}_{{s}_{i} , {s}_{i} + 1 , … , {s}_{i} + {n}_{i} - 1} - {\sum }_{j = 0}^{3} {\overline{D}}_{j}^{( m )} {\text{\textbar}}_{{s}_{i} , {s}_{i} + 1 , … , {s}_{i} + {n}_{i} - 1} \\ 1.1 ) demaping \\ 1.2 ) LDPC decoding to get {\hat{X}}_{0}^{( m )} , {\hat{X}}_{1}^{( m )} , {\hat{X}}_{2}^{( m )} , {\hat{X}}_{3}^{( m )} respactively , \\ where for i = 0 , 1 , 2 , 3 , {\hat{X}}_{i}^{( m )} {\vert}_{{s}_{j} , {s}_{j} + 1 , … , {s}_{j} + {n}_{j} - 1} = ( 0 , … , 0 ) if i \neq j\end{matrix}$ |
| 2) | If m = Tᵢ (max number of global iteration) output \hat{X}ᵢ^{(m)} |
| | Otherwise do 3) |
| 3) | $\begin{matrix}For i = 0 , 1 , 2 , 3 do \\ 3.1 ) {\hat{x}}_{i}^{( m )} = IDFT ( {\hat{X}}_{i}^{( m )} ) ; \\ 3.2 ) D ( {\hat{X}}_{i}^{( m )} , {g}_{i} ) = DFT ( {g}_{i} ( {\hat{x}}_{i}^{( m )} ) = {\hat{x}}^{( m )} ) \\ 3.3 ) {\overline{D}}_{i}^{( m )} = \frac{1}{m + 1} {\sum }_{k = 0}^{m} D ( {\hat{X}}_{i}^{( k )} , {g}_{i} ) \\ 3.4 ) m ← m + 1 , back to Step 1 )\end{matrix}$ |

Thus, in one implementation, a method for receive-side distortion cancellation in OFDM comprises, for each of a plurality of OFDM receivers: generating a distortion signal from a demapped and decoded first input signal; multiplying the distortion signal by a predetermined iteration factor; calculating an inverse Fourier transform of the multiplied distortion signal to generate an OFDM signal; calculating a Fourier transform of a difference of the OFDM signal and an amplified version of the OFDM signal to generate a noise signal; and mixing a received demodulated signal with an inverse of the noise signal and a noise signal received from each of the other OFDM receivers from the plurality of OFDM receivers to generate a second input signal.

FIG. 2D is a diagram illustrating a turbo distortion cancellation (TDC) method for an OFDM system according to another embodiment. The OFDM communication system receives signals and provides the signals to inverse Fourier transformer 201 to transform the signals to from frequency-domain to time-domain. The transformed signals are modulated at 203 and provided to a power amplifier (PA) 205. The power of the signals are amplified though the PA 205 using one or more PA models. The amplified signals are mixed with additive white Gaussian noise (AWGN) at 207. The mixed signals are demodulated at 209 and provided to a Fourier transformer (FFT) 227 according to some embodiments. The demodulated signals are provided to 211 to be processed with 1^{st} initialization, and provided to the FFT 227 according to some embodiments. The output of the FFT at 227 and the output of the 1^{st} initialization at 211 are provided to 213 for a 2^{nd} initialization. In some embodiments, the 2^{nd} initialization includes a predetermined number (e.g., u) of iterations to process the input signals at 213.

In some embodiments, the signals after PA and demodulation can be represented as:

r=x+d(x,f_{NL})+ñ (noise)

Wherein x represents the input signals, f_{NL} represents the PA function, n represents the noises generated through the processing of the signals, such as amplifying. d represents the demodulation function.

The 1^{st} initialization includes the following operations:
Step 1: compute y=f_{NL} (r);
Step 2: compute d(y,f_{NL})=y−r
Step 3: output Rₘ= [symbol] (r−d(y,f_{NL}))
   wherein [symbol] represents a unit discrete Fourier transform (DFT) function.

The output of the 1^{st} initialization Rₘ is provided to a 2^{nd} initialization at 213. The 2^{nd} initialization includes the following steps: Input Rₘ (from 1st initializaion) and R= [symbol] (r)

l ← 1

| | |
|---|---|
| 1) | $Compute {X}^{( l )} = {arg min}_{{X}_{i} : QAM constellat ion symbol} ‖ X - {R}_{m} ‖$ |
| 2) | If l = u (number of iterations required) output X^{(l)} |

else compute x^{(l)} = [symbol] ^{H} (X^{(l)})

| | |
|---|---|
| 3) | compute D(X^{(l)}, f_{NL}) = [symbol] (f_{NL} (x^{(l)}) − x^{(l)}) |
| 4) | compute Rₘ = R − ηₗD(X^{(l)}, f_{NL}) (ηₙ is a scaling coefficien t) |

if l = u output Rₘ else l ← l + 1 and go back to 1)

In some embodiments, the number of iterations is predetermined. In some embodiments, the number of iterations u is set as 3.

The output of the 2^{nd} initialization is added at 215 with transformed signal from 227 and signals from 225 to generate an input signal for global iteration in some embodiments. A combination of the signals at 215 is processed using a global iteration. The input signal for global iteration is provided for demapping at 217 and LDPC decoder at 219. The global iteration includes the following steps:

Start 1^{st} global iteration: q←1, and 1) InputRₘ from initializaion or ANDG,

| 1) | $compute sMet ( n , i ) = log Pr ( {X}_{n} = {Q}_{i} \vert {R}_{m , n} ) = \frac{- {‖ {Q}_{i} - {R}_{m , n} ‖}^{2}}{2 {σ}_{n}^{2}} ,$ | |
|---|---|---|
| | Qᵢ : an m - bits constellation signal | |
| 2) | compute bit LLR from sMet(n, i) and Pₐₚ : LLR(b₍ₙ₋₁₎ₘ₊ᵢ), i = 0, K, m − 1. | |
| 3) | do L iterations LDPC decoding based on LLR(b₍ₙ₋₁₎ₘ₊ᵢ), i = 0, K, m − 1, n = 0, | |
| | K, N − 1 | |
| | output a) | estimated symbols X^{(q)} = (X₀^{(q)}, Λ, X_{N-1}^{(q)}) |
| | b) | posterior probability Pₚₚ of the estimated constellation symbol based on |
| | | the extrinsic LLR generated by the LDPC decoder. Pₚₚ will feedback to |
| | | to demapping in the next globle iteration as a prior probablity Pₐₚ |

At the q-th global iteration, if the X is convergent, the X is outputted and the TDC process is ended. If the X is not convergent, the X is provided to an accumulate nonlinear distortion generator (ANDG). The ANDG includes a nonlinear distortion generator 221, an input to the ANDG is processed by the nonlinear distortion generator 221. The output signal was accumulated at 223 and 225 such that a number of outputs of the nonlinear distortion generator are added at 223 and 225 to generate an accumulated signal. The ANDG is configured to processing the following steps:
Input X^{(q)} from LDPC decoder and AND (X^{(q-1)}),
where AND (X⁽⁰⁾)=D(X⁽⁰⁾, f_{NL}) is from 1st or 2nd initialization
   1: compute x^{(q)}= [symbol] ^{H}X^{(q)}
   2: compute dᵢ(x^{(q)}, f_{NL})=f_{NL}(xᵢ(q))−xᵢ^{(q)}=0,K, N−1
   3: compute D(X^{(q)},f_{NL})= [symbol] (d₀ (x^{(q)},f_{NL}),Λ, d_{N-1}(x^{(q)}, f_{NL}))^{T}
   4: compute AND (X^{(q)})=AND(X^{(q-1)})+D(X^{(q)} f_{NL})

After performing the ANDG computation:

$${R}_{m} = R - \frac{1}{q + 1} AND ( {X}^{( q )} )$$

If q is not at a particular level (e.g., maximal) yet, q is incremented, qϕq+1, and demapping 217 and LDPC decoding 219 are repeated.

The TDC method as discussed above can be applied to any PA models. As discussed above, a nonlinear PA model can be expanded based on Taylor theory and represented as:

Vₒᵤₜ=a₁Vᵢₙ(t)+a₁Vᵢₙ(t)+a₂Vᵢₙ²(t)+a₃Vᵢₙ³(t)+a₄Vᵢₙ⁴(t)+a₅Vᵢₙ⁵(t)

Consider a case in which the input signal is Vᵢₙ=A(t)cos(ω_{c}t)

$${a}_{1} {V}_{1} ( t ) = {a}_{1} A ( t ) cos ( {ω}_{c} t )$$

$${a}_{2} {V}_{in}^{2} ( t ) = \frac{1}{2} {a}_{2} {A}^{2} ( t ) + \frac{1}{2} {a}_{2} {A}^{2} ( t ) cos ( 2 {ω}_{c} t )$$

$${a}_{3} {V}_{in}^{3} ( t ) = \frac{3}{2} {a}_{3} {A}^{3} ( t ) cos ( {ω}_{c} t ) + \frac{1}{4} {a}_{3} {A}^{3} ( t ) cos ( 3 {ω}_{c} t )$$

$${a}_{4} {V}_{in}^{4} ( t ) = \frac{3}{8} {a}_{4} {A}^{4} ( t ) + {a}_{4} \frac{{A}^{4}}{4} {a}_{3} {A}^{4} ( t ) cos ( 2 {ω}_{c} t ) + \frac{1}{8} {a}_{4} {A}^{4} ( t ) cos ( 4 {ω}_{c} t )$$

$${a}_{5} {V}_{in}^{5} ( t ) = \frac{5}{8} {a}_{5} {A}^{5} ( t ) cos ( {ω}_{c} t ) + \frac{5}{16} {a}_{5} {A}^{5} ( t ) cos ( 3 {ω}_{c} t ) + \frac{1}{16} {a}_{5} {A}^{5} ( t ) cos ( 5 {ω}_{c} t )$$

$$Thus , {V}_{out} ( t ) = ( {a}_{1} A ( t ) + \frac{3}{4} {a}_{3} {A}^{3} ( t ) + \frac{5}{8} {a}_{5} {A}^{5} ( t ) ) cos ( {ω}_{c} t )$$

The value of ⅝a₅A⁵(t) is relatively smaller than the value of ¾a₃A³(t), thus, the term ⅝a₅A⁵(t) can be neglected. Therefore, the nonlinear PA model can be simplified as a 3^{rd} order harmonic PA model and can be represented as:

Vₒᵤₜ(t)=Vᵢₙ(t)a₃Vᵢₙ³(t)

Thus, in some embodiments, the 3^{rd} order harmonic PA model is generally represented as:

Vₒᵤₜ=a₁Vᵢₙ+a₂Vᵢₙ²+a₃Vᵢₙ³

The polynomial coefficients can be simplified by partial derivatives, such as:

$${a}_{1} = \frac{\partial {V}_{out}}{\partial {V}_{in}} {\vert}_{v in = 0} = - Rd \sqrt{{μ}_{n} {C}_{ox} \frac{W}{L} {I}_{bias}}$$

$${a}_{2} = \frac{{\partial }^{2} {V}_{out}}{\partial {V}_{in}^{2}} {\vert}_{v in = 0} = 0$$

$${a}_{3} = \frac{{\partial }^{3} {V}_{out}}{\partial {V}_{in}^{3}} {\vert}_{v in = 0} = \frac{3}{4} Rd \frac{{( {μ}_{n} {C}_{ox} \frac{W}{L} )}^{\frac{3}{2}}}{\sqrt{{I}_{bias}}}$$

The polynomial coefficients are normalized, so that the PA model is simplified as:

$${\overline{V}}_{out} = {V}_{in} + \frac{{a}_{3}}{{a}_{1}} {V}_{in}^{3}$$

$${\overline{a}}_{3} = - \frac{{a}_{3}}{{a}_{1}} = \frac{3}{4} \frac{{μ}_{n} {C}_{ox} \frac{W}{L}}{{I}_{bias}} > 0 \\ ⇒ {\overline{V}}_{out} = {V}_{in} - {\overline{a}}_{3} {V}_{in}^{3}$$

In some embodiments, increasing the bias current I_{bias} lowers the coefficient ā₃ and improves distributed amplifier linearity.

In some embodiments, the PA is a device that uses Metal-Oxide semiconductor field-effect transistor (MOSFET). The MOSFET can have a transfer characteristic function of the differential pair transconductor represented as:

$$Δ {V}_{out} = - \frac{1}{2} {μ}_{n} {C}_{ox} \frac{W}{L} {R}_{d} Δ {V}_{in} \sqrt{\frac{4 {I}_{bias}}{{μ}_{n} {C}_{ox} \frac{W}{L}} - Δ {V}_{in}^{2}}$$

$${μ}_{n} \text{:} electron mobility of charge carriers$$

$${C}_{ox} \text{:} capacitance per unit gate area of the oxdie layer$$

$$\frac{W}{L} \text{:} aspect ratio$$

$${R}_{d} \text{:} drain parasitic resistance$$

$${I}_{bias} \text{:} DC bias current ( {I}_{bias} = \frac{{V}_{cc} - {V}_{BE}}{{R}_{bias}} )$$

The output of the PA is

$$y = {f}_{NL} ( x ) = x - {a}_{3} {x}^{3}$$

$${a}_{3} > 0$$

The output of the PA is provided for demodulation using the following processes:

$$AfterPA$$

$${f}_{NL} ( x ( t ) ) = x ( t ) - {{a}_{3} [ x ( t ) ]}^{3} = I ( t ) cos ( {ω}_{c} t ) - Q ( t ) sin ( {ω}_{c} t ) - {a}_{3} [ {I}^{3} ( t ) {cos}^{3} ( {ω}_{c} t ) - 3 {I}^{2} ( t ) Q ( t ) {cos}^{2} ( {ω}_{c} t ) sin ( {ω}_{c} t ) + 3 I ( t ) {Q}^{2} ( t ) cos ( {ω}_{c} t ) {sin}^{2} ( {ω}_{c} t ) - {Q}^{3} ( t ) {sin}^{3} ( {ω}_{c} t ) ]$$

Applying the following formulas:

$$cos X cos Y = ( 1 / 2 ) [ cos ( X - Y ) + cos ( X + Y ) ] \\ sin X cos Y = ( 1 / 2 ) [ sin ( X + Y ) + sin ( X - Y ) ] \\ cos X sin Y = ( 1 / 2 ) [ sin ( X + Y ) - sin ( X - Y ) ] \\ sin X sin Y = ( 1 / 2 ) [ cos ( X - Y ) - cos ( X + Y ) ] \\ {sin}^{2} X = 1 / 2 - ( 1 / 2 ) cos ( 2 X ) ) \\ {cos}^{2} X = 1 / 2 + ( 1 / 2 ) cos ( 2 X ) )$$

$${sin}^{3} X = ( 3 / 4 ) sin X - ( 1 / 4 ) sin ( 3 X )$$

$${cos}^{3} X = ( 3 / 4 ) cos X + ( 1 / 4 ) cos ( 3 X )$$

$${sin}^{4} X = ( 3 / 8 ) - ( 1 / 2 ) cos ( 2 X ) + ( 1 / 8 ) cos ( 4 X )$$

$${cos}^{4} X = ( 3 / 8 ) + ( 1 / 2 ) cos ( 2 X ) + ( 1 / 8 ) cos ( 4 X )$$

$$Thus , \\ \tilde{I} ( t ) = 2 y ( t ) cos ( {ω}_{c} t ) = 2 \{ x ( t ) - {{a}_{3} [ x ( t ) ]}^{3} \} cos ( {ω}_{c} t ) = 2 \{ I ( t ) cos ( {ω}_{c} t ) - Q ( t ) sin ( {ω}_{c} t ) - {a}_{3} [ {I}^{3} ( t ) {cos}^{3} ( {ω}_{c} t ) - 3 {I}^{2} ( t ) Q ( t ) {cos}^{2} ( {ω}_{c} t ) sin ( ω t ) + 3 I ( t ) {Q}^{2} ( t ) cos ( {ω}_{c} t ) {sin}^{2} ( {ω}_{c} t ) - {Q}^{3} ( t ) {sin}^{3} ( {ω}_{c} t ) ] \} cos ( {ω}_{c} t ) = \text{?} - \text{?} - \text{?} + \text{?} - \text{?} + \text{?}$$

$$A = 2 I ( t ) {cos}^{2} ( {ω}_{c} t ) = I ( t ) + I ( t ) cos ( 2 {ω}_{c} t )$$

$$B = 2 Q ( t ) sin ( {ω}_{c} t ) cos ( {ω}_{c} t ) = sin ( 2 {ω}_{c} t )$$

$$C = 2 {a}_{3} {I}^{3} ( t ) {cos}^{4} ( {ω}_{c} t ) = 2 {a}_{3} {I}^{3} ( t ) [ \frac{3}{8} + \frac{1}{2} cos ( 2 {ω}_{c} t ) + \frac{1}{8} cos ( 4 {ω}_{c} t ) ] = \frac{3}{4} {a}_{3} {I}^{3} ( t ) + {a}_{3} {I}^{3} ( t ) cos ( 2 {ω}_{c} t ) + \frac{1}{4} {a}_{3} {I}^{3} ( t ) cos ( 4 {ω}_{c} t )$$

$$D = 6 {a}_{3} {I}^{3} ( t ) Q ( t ) {cos}^{3} ( {ω}_{c} t ) sin ( {ω}_{c} t ) = 6 {a}_{3} {I}^{2} ( t ) Q ( t ) [ \frac{3}{4} cos ( {ω}_{c} t ) + \frac{1}{4} cos ( 3 {ω}_{c} t ) ] sin ( {ω}_{c} t ) = 6 {a}_{3} {I}^{2} ( t ) Q ( t ) [ \frac{3}{8} sin ( 2 {ω}_{c} t ) + \frac{1}{8} ( sin ( 4 {ω}_{c} t ) - sin ( 2 {ω}_{c} t ) ) ] = {a}_{3} {I}^{3} ( t ) Q ( t ) [ \frac{3}{2} sin ( 2 {ω}_{c} t ) + \frac{3}{4} sin ( 4 {ω}_{c} t ) ]$$

$$E = 6 {a}_{3} I ( t ) {Q}^{2} ( t ) {cos}^{2} ( {ω}_{c} t ) {sin}^{2} ( ω t ) = 6 I ( t ) {{Q}^{2} ( t ) [ cos ( {ω}_{c} t ) sin ( {ω}_{c} t ) ]}^{2} = 6 {a}_{3} I ( t ) {Q}^{2} ( t ) [ \frac{1}{4} {sin}^{2} ( 2 {ω}_{c} t ) ] = \frac{3}{2} I ( t ) {Q}^{2} ( t ) [ \frac{1}{2 } ( 1 - cos ( 2 {ω}_{c} t ) ) ] = \frac{3}{4} {a}_{3} I ( t ) {Q}^{2} ( t ) - \frac{3}{4} {a}_{3} I ( t ) {Q}^{2} ( t ) cos ( 2 {ω}_{c} t ) \\ F = 2 {a}_{3} {Q}^{3} ( t ) {sin}^{3} ( {ω}_{c} t ) cos ( {ω}_{c} t ) = 2 {a}_{3} {Q}^{3} ( t ) [ \frac{3}{4} sin ( {ω}_{c} t ) - \frac{1}{4} sin ( 3 {ω}_{c} t ) ] cos ( {ω}_{c} t ) = {a}_{3} {Q}^{3} ( t ) [ \frac{3}{2} sin ( {ω}_{c} t ) cos ( {ω}_{c} t ) - \frac{1}{2} sin ( 3 {ω}_{c} t ) cos ( {ω}_{c} t ) ] = {a}_{3} {Q}^{3} ( t ) [ \frac{3}{4} sin ( 2 {ω}_{c} t ) - \frac{1}{4} sin ( 4 {ω}_{c} t ) - \frac{1}{4} sin ( 2 {ω}_{c} t ) ] = {a}_{3} {Q}^{3} ( t ) [ \frac{1}{2} sin ( 2 {ω}_{c} t ) - \frac{1}{4} sin ( 4 {ω}_{c} t ) ]$$

$$\tilde{I} ( t ) = A - B - C + D - E + F = I ( t ) + I ( t ) cos ( 2 {ω}_{c} t ) - sin ( 2 {ω}_{c} t ) - ( \frac{3}{4} {a}_{3} {I}^{3} ( t ) + {a}_{3} {I}^{3} ( t ) cos ( 2 {ω}_{c} t ) + \frac{1}{4} {a}_{3} {I}^{3} ( t ) cos ( 4 {ω}_{c} t ) ) + {a}_{3} {I}^{2} ( t ) Q ( t ) [ \frac{3}{2} sin ( 2 {ω}_{c} t ) + \frac{3}{4} sin ( 4 {ω}_{c} t ) ] - ( \frac{3}{4} {a}_{3} I ( t ) {Q}^{2} ( t ) - \frac{3}{4} {a}_{3} I ( t ) {Q}^{2} ( t ) cos ( 2 {ω}_{c} t ) ) - {a}_{3} {Q}^{3} ( t ) [ \frac{1}{2} sin ( 2 {ω}_{c} t ) - \frac{1}{4} sin ( 4 {ω}_{c} t ) ] = ( I ( t ) - \frac{3}{4} {a}_{3} {I}^{3} ( t ) - \frac{3}{4} {a}_{3} I ( t ) {Q}^{2} ( t ) ) + \text{?} + \text{?} - \text{?} \\ \text{?} \text{indicates text missing or illegible when filed}$$

After applying low pass filters, the demodulation results I and Q are represented as:

Ĩ(t)=I(t)−¾a₃[I³(t)+I(t)Q²(t)]=I(t)−¾ a₃[I²(t)+Q²(t)]I(t)

Similarly,

\tilde{Q}(t)=Q(t)−¾a₃[Q³(t)+Q(t)I²(t)]=Q(t)−¾a₃[I²(t)+Q²(t)]Q(t)

After 3rd order harmonic PA f_{NL}(x)=x−a₃x³ and demodulation we get

$${f}_{NL} ( s ( t ) ) = \tilde{I} ( t ) + j \tilde{Q} ( t ) = ( I ( t ) + jQ ( t ) ) - \frac{3}{4} {a}_{3} {‖ I ( t ) + jQ ( t ) ‖}^{2} ( I ( t ) + jQ ( t ) ) = s ( t ) - \frac{3}{4} {a}_{3} {‖ s ( t ) ‖}^{2} s ( t )$$

FIG. 3C is a flow chart of an implementation of a method for turbo distortion cancellation in an OFDMA-TDC receiver. As shown, the receiver may receive an OFDM signal at step 350, and at step 352, may subtract a distortion signal received from the receiver's own TDC circuit, as well as the TDC circuits of each other receiver (e.g. corresponding to each other channel utilized to transmit the OFDM data). At step 354, the “clean” signal with intra-channel and inter-channel distortion reduced or removed may be demapped and decoded, and at step 356, may be provided to a processor of the device for further action (e.g. demultiplexing, providing to a network stack, etc.).

The demapped and decoded signal may also be provided to the distortion cancellation circuit of the receiver. At step 358, the receiver may generate a noise signal from the input signal, as discussed above. Generating the noise signal may comprise performing an inverse Fourier transform, subtracting the resulting signal from an amplified version of the resulting signal, and performing a Fourier transform on the difference. At step 360, the noise signal may be multiplied by a weighting coefficient and added to previous weighted noise signals for a number of iterations (e.g. 4 iterations, in some implementations). The weighting coefficient may be inversely proportional to the order of receipt of the signal, such as 1/m+1 with m being 0 for the most recently received signal (e.g. with a weight of 1); m being 1 for the next most recently received signal (e.g. with a weight of ½); etc. Thus, the resulting noise signal is a weighted sum of prior noise signals, with earlier signals having less effect.

When the addition is complete, the resulting signal may be mapped to OFDM symbols at step 362, and provided to the mixer of the receiver for subtraction at step 352, as well as provided to the mixers of other receivers.

Accordingly, in one aspect, the present disclosure is directed to a system for receive-side distortion cancellation in orthogonal frequency division multiplexing (OFDM). The system includes a nonlinear distortion generator, configured to receive a plurality of demapped and decoded input signals received via a first channel, and generate a corresponding plurality of noise signals. The system also includes an iterative feedback mixer circuit configured to generate an output distortion signal comprising a weighted sum of the plurality of noise signals. The system also includes a mapper circuit configured to map the output distortion signal to OFDM symbols to generate a symbol-mapped noise representation. The system also includes a second mixer circuit configured to subtract the symbol-mapped noise representation from a further input signal.

In some implementations, the nonlinear distortion generator is configured to generate the plurality of noise signals by, for each input signal, calculating an inverse Fourier transform of said input signal to generate an intermediate signal, and calculating a Fourier transform of a difference of the intermediate signal and an amplified version of the intermediate signal to generate a noise signal. In some implementations, the weighted sum comprises a sum of a predetermined number of noise signals, each of the noise signals multiplied by a coefficient inversely proportional to an order of reception of the corresponding input signal.

In some implementations, the iterative feedback mixer circuit comprises a buffer storing a predetermined number of prior noise signals. In some implementations, the second mixer circuit is further configured to subtract additional symbol-mapped noise representations received from additional mapper circuits corresponding to additional channels from the further input signal. In some implementations, the system includes a decoder configured to receive the further input signal after subtraction of the symbol-mapped noise representation, decode the signal, and provide the decoded output to a processor.

In another aspect, the present disclosure is directed to a system for receive-side distortion cancellation in orthogonal frequency division multiplexing (OFDM). The system includes a plurality of distortion cancellation circuits, each associated with a channel of a plurality of channels of a received OFDM signal. Each distortion cancellation circuit of the plurality of distortion cancellation circuits is configured to subtract, from an input signal of a corresponding channel, a plurality of noise representations generated by the plurality of distortion cancellation circuits, each noise representation iteratively generated as a weighted sum of a plurality of noise signals of a single channel of the plurality of channels.

In some implementations, each distortion cancellation circuit comprises a nonlinear distortion generator configured to generate one of the plurality of noise signals. In a further implementation, each nonlinear distortion generator is configured to calculate a Fourier transform of a difference between an inverse Fourier transform of a decoded input signal and an amplified version of the inverse Fourier transform of the decoded input signal to generate the noise signal.

In some implementations, each distortion cancellation circuit comprises an OFDM symbol mapper configured to map the noise representation to OFDM symbols, and provide the mapped noise representation to each other distortion cancellation circuit. In some implementations, each distortion cancellation circuit comprises a buffer storing a predetermined plurality of previously generated noise signals.

In a further implementation, each distortion cancellation circuit comprises a mixer configured to add each of the predetermined plurality of previously generated noise signals multiplied by a weighting coefficient. In a still further implementation, the weighting coefficient is inversely proportional to an order of generation of the corresponding noise signal.

In another aspect, the present disclosure is directed to a method for receive-side distortion cancellation in orthogonal frequency division multiplexing (OFDM). The method includes receiving, by a nonlinear distortion generator, a plurality of demapped and decoded input signals received via a first channel. The method also includes generating, by the nonlinear distortion generator, a corresponding plurality of noise signals. The method also includes generating, by an iterative feedback mixer circuit, an output distortion signal comprising a weighted sum of the plurality of noise signals. The method also includes mapping, by an OFDM mapper circuit, the output distortion signal to OFDM symbols to generate a symbol-mapped noise representation. The method also includes subtracting, by a second mixer circuit, the symbol-mapped noise representation from a further input signal.

In some implementations, generating the plurality of noise signals includes, for each input signal, calculating an inverse Fourier transform of said input signal to generate an intermediate signal. In a further implementation, generating the plurality of noise signals includes, for each input signal, calculating a Fourier transform of a difference of the intermediate signal and an amplified version of the intermediate signal to generate a noise signal.

In some implementations, the weighted sum comprises a sum of a predetermined number of noise signals, each of the noise signals multiplied by a coefficient inversely proportional to an order of reception of the corresponding input signal. In some implementations, the method includes storing, by a buffer of the iterative feedback mixer circuit, a predetermined number of prior noise signals. In some implementations, the method includes subtracting, by the second mixer circuit, additional symbol-mapped noise representations received from additional mapper circuits corresponding to additional channels from the further input signal. In some implementations, the method includes decoding, by a decoder, the further input signal after subtraction of the symbol-mapped noise representation, and providing the decoded output to a processor.

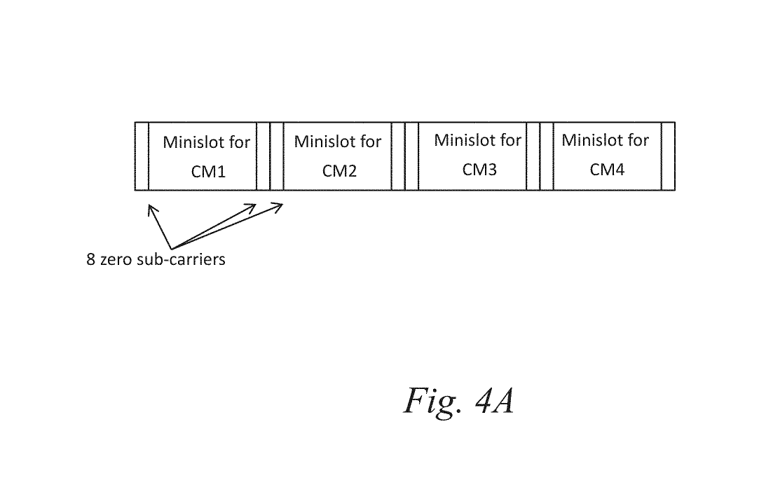

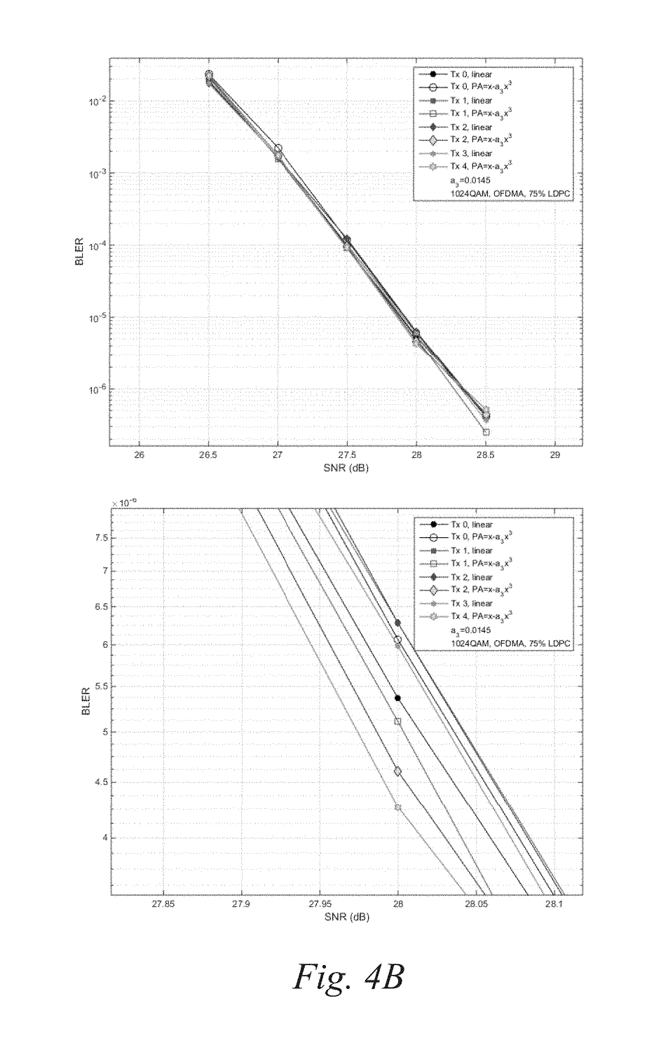

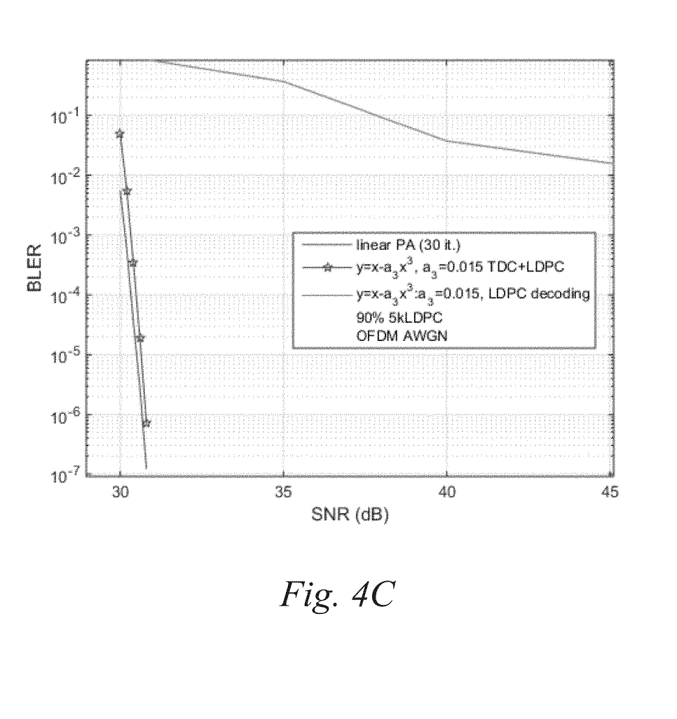

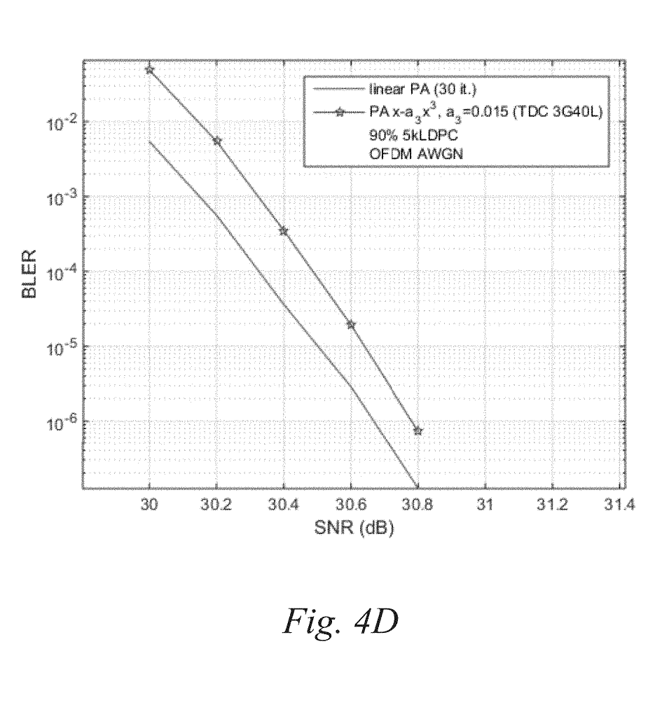

The system discussed herein has been validated with experimental test data and measurements. FIG. 4A is an illustration of a modulation scheme used to test an example embodiment of an OFDMA-TDC system, with 8 zero subcarriers bordering minislots corresponding to each modem. FIG. 4B depicts graphs of performance of an implementation of a test of an OFDMA-TDC system, the lower graph showing an expanded portion of the upper graph near an area of highest signal to noise ratios. As shown, error rates are low, and there is almost no difference in the performance of linear (solid symbols) and non-linear (open symbols) amplifiers.

FIG. 4C depicts a graph of performance of an implementation of a test of an OFDM-TDC system. For a 3^{rd} order harmonic PA with third order factor as 0.015, when the system is applied with TDC and the LDPC as discussed above, the system would perform with lower error rate and lower signal to noise ratio compared to the system that is applied with only LDPC. The system with TDC and LDPC enables the nonlinear PA (e.g., 3^{rd} order harmonic PA) to perform similarly to a linear PA.

FIG. 4D depicts a graph of performance of an implementation of a test of an TDC system. For a 3^{rd} order harmonic PA with third order factor as 0.015, when the system is applied with TDC only, the system has a performance that has a 0.1 dB loss compared to the linear PA.

### B. Computing and Network Environment

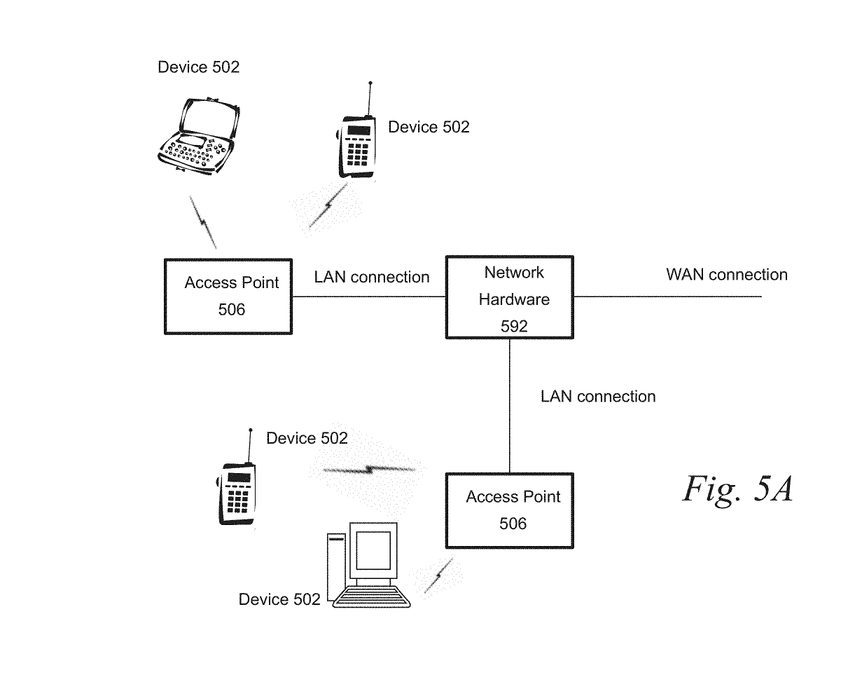

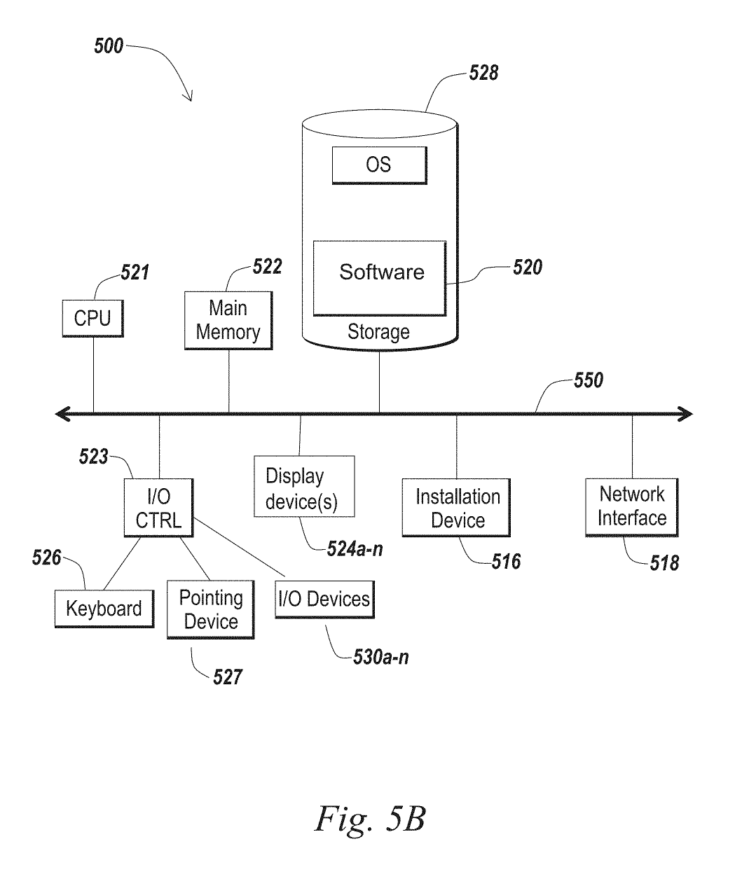

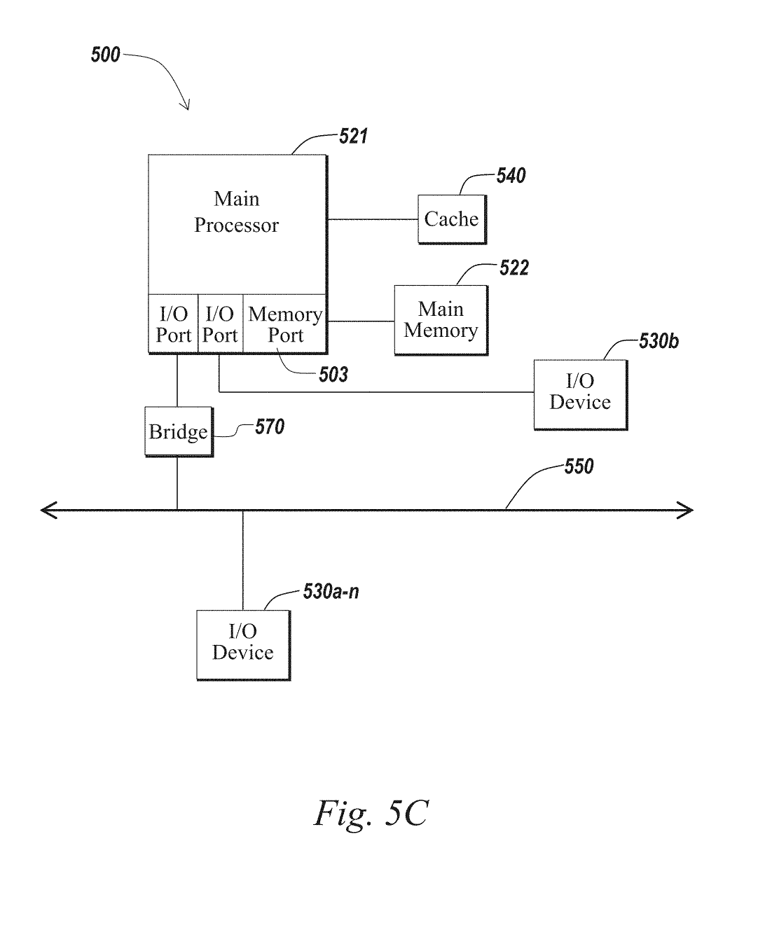

Having discussed specific embodiments of the present solution, it may be helpful to describe aspects of the operating environment as well as associated system components (e.g., hardware elements) in connection with the methods and systems described herein. Referring to FIG. 5A, an embodiment of a network environment is depicted. In brief overview, the network environment includes a wireless communication system that includes one or more access points 506, one or more wireless communication devices 502 and a network hardware component 592. The wireless communication devices 502 may for example include laptop computers 502, tablets 502, personal computers 502 and/or cellular telephone devices 502. The details of an embodiment of each wireless communication device and/or access point are described in greater detail with reference to FIGS. 5B and 5C. The network environment can be an ad hoc network environment, an infrastructure wireless network environment, a subnet environment, etc. in one embodiment

The access points (APs) 506 may be operably coupled to the network hardware 592 via local area network connections. The network hardware 592, which may include a router, gateway, switch, bridge, modem, system controller, appliance, etc., may provide a local area network connection for the communication system. Each of the access points 506 may have an associated antenna or an antenna array to communicate with the wireless communication devices 502 in its area. The wireless communication devices 502 may register with a particular access point 506 to receive services from the communication system (e.g., via a SU-MIMO or MU-MIMO configuration). For direct connections (e.g., point-to-point communications), some wireless communication devices 502 may communicate directly via an allocated channel and communications protocol. Some of the wireless communication devices 502 may be mobile or relatively static with respect to the access point 506.

In some embodiments an access point 506 includes a device or module (including a combination of hardware and software) that allows wireless communication devices 502 to connect to a wired network using Wi-Fi, or other standards. An access point 506 may sometimes be referred to as an wireless access point (WAP). An access point 506 may be configured, designed and/or built for operating in a wireless local area network (WLAN). An access point 506 may connect to a router (e.g., via a wired network) as a standalone device in some embodiments. In other embodiments, an access point can be a component of a router. An access point 506 can provide multiple devices 502 access to a network. An access point 506 may, for example, connect to a wired Ethernet connection and provide wireless connections using radio frequency links for other devices 502 to utilize that wired connection. An access point 506 may be built and/or configured to support a standard for sending and receiving data using one or more radio frequencies. Those standards, and the frequencies they use may be defined by the IEEE (e.g., IEEE 802.11 standards). An access point may be configured and/or used to support public Internet hotspots, and/or on an internal network to extend the network's Wi-Fi signal range.

In some embodiments, the access points 506 may be used for (e.g., in-home or in-building) wireless networks (e.g., IEEE 802.11, Bluetooth, ZigBee, any other type of radio frequency based network protocol and/or variations thereof). Each of the wireless communication devices 502 may include a built-in radio and/or is coupled to a radio. Such wireless communication devices 502 and/or access points 506 may operate in accordance with the various aspects of the disclosure as presented herein to enhance performance, reduce costs and/or size, and/or enhance broadband applications. Each wireless communication devices 502 may have the capacity to function as a client node seeking access to resources (e.g., data, and connection to networked nodes such as servers) via one or more access points 506.

The network connections may include any type and/or form of network and may include any of the following: a point-to-point network, a broadcast network, a telecommunications network, a data communication network, a computer network. The topology of the network may be a bus, star, or ring network topology. The network may be of any such network topology as known to those ordinarily skilled in the art capable of supporting the operations described herein. In some embodiments, different types of data may be transmitted via different protocols. In other embodiments, the same types of data may be transmitted via different protocols.

The communications device(s) 502 and access point(s) 506 may be deployed as and/or executed on any type and form of computing device, such as a computer, network device or appliance capable of communicating on any type and form of network and performing the operations described herein. FIGS. 5B and 5C depict block diagrams of a computing device 500 useful for practicing an embodiment of the wireless communication devices 502 or the access point 506. As shown in FIGS. 5B and 5C, each computing device 500 includes a central processing unit 521, and a main memory unit 522. As shown in FIG. 5B, a computing device 500 may include a storage device 528, an installation device 516, a network interface 518, an I/O controller 523, display devices 524a-524n, a keyboard 526 and a pointing device 527, such as a mouse. The storage device 528 may include, without limitation, an operating system and/or software. As shown in FIG. 5C, each computing device 500 may also include additional optional elements, such as a memory port 503, a bridge 570, one or more input/output devices 530a-530n (generally referred to using reference numeral 530), and a cache memory 540 in communication with the central processing unit 521.

The central processing unit 521 is any logic circuitry that responds to and processes instructions fetched from the main memory unit 522. In many embodiments, the central processing unit 521 is provided by a microprocessor unit, such as: those manufactured by Intel Corporation of Mountain View, Calif.; those manufactured by International Business Machines of White Plains, N.Y.; or those manufactured by Advanced Micro Devices of Sunnyvale, Calif. The computing device 500 may be based on any of these processors, or any other processor capable of operating as described herein.

Main memory unit 522 may be one or more memory chips capable of storing data and allowing any storage location to be directly accessed by the microprocessor 521, such as any type or variant of Static random access memory (SRAM), Dynamic random access memory (DRAM), Ferroelectric RAM (FRAM), NAND Flash, NOR Flash and Solid State Drives (SSD). The main memory 522 may be based on any of the above described memory chips, or any other available memory chips capable of operating as described herein. In the embodiment shown in FIG. 5B, the processor 521 communicates with main memory 522 via a system bus 550 (described in more detail below). FIG. 5C depicts an embodiment of a computing device 500 in which the processor communicates directly with main memory 522 via a memory port 503. For example, in FIG. 5C the main memory 522 may be DRDRAM.

FIG. 5C depicts an embodiment in which the main processor 521 communicates directly with cache memory 540 via a secondary bus, sometimes referred to as a backside bus. In other embodiments, the main processor 521 communicates with cache memory 540 using the system bus 550. Cache memory 540 typically has a faster response time than main memory 522 and is provided by, for example, SRAM, BSRAM, or EDRAM. In the embodiment shown in FIG. 5C, the processor 521 communicates with various I/O devices 530 via a local system bus 550. Various buses may be used to connect the central processing unit 521 to any of the I/O devices 530, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 524, the processor 521 may use an Advanced Graphics Port (AGP) to communicate with the display 524. FIG. 5C depicts an embodiment of a computer 500 in which the main processor 521 may communicate directly with I/O device 530b, for example via HYPERTRANSPORT, RAPIDIO, or INFINIBAND communications technology. FIG. 5C also depicts an embodiment in which local busses and direct communication are mixed: the processor 521 communicates with I/O device 530a using a local interconnect bus while communicating with I/O device 530b directly.

A wide variety of I/O devices 530a-530n may be present in the computing device 500. Input devices include keyboards, mice, trackpads, trackballs, microphones, dials, touch pads, touch screen, and drawing tablets. Output devices include video displays, speakers, inkjet printers, laser printers, projectors and dye-sublimation printers. The I/O devices may be controlled by an I/O controller 523 as shown in FIG. 5B. The I/O controller may control one or more I/O devices such as a keyboard 526 and a pointing device 527, e.g., a mouse or optical pen. Furthermore, an I/O device may also provide storage and/or an installation medium 516 for the computing device 500. In still other embodiments, the computing device 500 may provide USB connections (not shown) to receive handheld USB storage devices such as the USB Flash Drive line of devices manufactured by Twintech Industry, Inc. of Los Alamitos, Calif.

Referring again to FIG. 5B, the computing device 500 may support any suitable installation device 516, such as a disk drive, a CD-ROM drive, a CD-R/RW drive, a DVD-ROM drive, a flash memory drive, tape drives of various formats, USB device, hard-drive, a network interface, or any other device suitable for installing software and programs. The computing device 500 may further include a storage device, such as one or more hard disk drives or redundant arrays of independent disks, for storing an operating system and other related software, and for storing application software programs such as any program or software 520 for implementing (e.g., configured and/or designed for) the systems and methods described herein. Optionally, any of the installation devices 516 could also be used as the storage device. Additionally, the operating system and the software can be run from a bootable medium.

Furthermore, the computing device 500 may include a network interface 518 to interface to the network 504 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax and direct asynchronous connections). In one embodiment, the computing device 500 communicates with other computing devices 500′ via any type and/or form of gateway or tunneling protocol such as Secure Socket Layer (SSL) or Transport Layer Security (TLS). The network interface 518 may include a built-in network adapter, network interface card, PCMCIA network card, card bus network adapter, wireless network adapter, USB network adapter, modem or any other device suitable for interfacing the computing device 500 to any type of network capable of communication and performing the operations described herein.

In some embodiments, the computing device 500 may include or be connected to one or more display devices 524a-524n. As such, any of the I/O devices 530a-530n and/or the I/O controller 523 may include any type and/or form of suitable hardware, software, or combination of hardware and software to support, enable or provide for the connection and use of the display device(s) 524a-524n by the computing device 500. For example, the computing device 500 may include any type and/or form of video adapter, video card, driver, and/or library to interface, communicate, connect or otherwise use the display device(s) 524a-524n. In one embodiment, a video adapter may include multiple connectors to interface to the display device(s) 524a-524n. In other embodiments, the computing device 500 may include multiple video adapters, with each video adapter connected to the display device(s) 524a-524n. In some embodiments, any portion of the operating system of the computing device 500 may be configured for using multiple displays 524a-524n. One ordinarily skilled in the art will recognize and appreciate the various ways and embodiments that a computing device 500 may be configured to have one or more display devices 524a-524n.

In further embodiments, an I/O device 530 may be a bridge between the system bus 550 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached small computer system interface bus, a USB connection, or a HDMI bus.

A computing device 500 of the sort depicted in FIGS. 5B and 5C may operate under the control of an operating system, which control scheduling of tasks and access to system resources. The computing device 500 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: Android, produced by Google Inc.; WINDOWS 7 and 8, produced by Microsoft Corporation of Redmond, Wash.; MAC OS, produced by Apple Computer of Cupertino, Calif.; WebOS, produced by Research In Motion (RIM); OS/2, produced by International Business Machines of Armonk, N.Y.; and Linux, a freely-available operating system distributed by Caldera Corp. of Salt Lake City, Utah, or any type and/or form of a Unix operating system, among others.

The computer system 500 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 500 has sufficient processor power and memory capacity to perform the operations described herein.

In some embodiments, the computing device 500 may have different processors, operating systems, and input devices consistent with the device. For example, in one embodiment, the computing device 500 is a smart phone, mobile device, tablet or personal digital assistant. In still other embodiments, the computing device 500 is an Android-based mobile device, an iPhone smart phone manufactured by Apple Computer of Cupertino, Calif., or a Blackberry or WebOS-based handheld device or smart phone, such as the devices manufactured by Research In Motion Limited. Moreover, the computing device 500 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users”, such “users” may refer to user-associated devices or stations (STAs), for example, consistent with the terms “user” and “multi-user” typically used in the context of a multi-user multiple-input and multiple-output (MU-MIMO) environment.

Although examples of communications systems described above may include devices and APs operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein.

It should be noted that certain passages of this disclosure may reference terms such as “first” and “second” in connection with devices, mode of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components and these components may be provided on either a standalone machine or, in some embodiments, on multiple machines in a distributed system. In addition, the systems and methods described above may be provided as one or more computer-readable programs or executable instructions embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, or in any byte code language such as JAVA. The software programs or executable instructions may be stored on or in one or more articles of manufacture as object code.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A system for receive-side distortion cancellation in orthogonal frequency division multiplexing (OFDM), comprising:
a nonlinear distortion generator, configured to receive a plurality of demapped and decoded input signals received via a first channel, and generate a corresponding plurality of noise signals;
an iterative feedback mixer circuit configured to generate an output distortion signal comprising a weighted sum of the plurality of noise signals;
a mapper circuit configured to map the output distortion signal to OFDM symbols to generate a symbol-mapped noise representation; and
a second mixer circuit configured to subtract the symbol-mapped noise representation from a further input signal.

2. The system of claim 1, wherein the nonlinear distortion generator is configured to generate the plurality of noise signals by, for each input signal, calculating an inverse Fourier transform of said input signal to generate an intermediate signal, and calculating a Fourier transform of a difference of the intermediate signal and an amplified version of the intermediate signal to generate a noise signal.

3. The system of claim 1, wherein the weighted sum comprises a sum of a predetermined number of noise signals, each of the noise signals multiplied by a coefficient inversely proportional to an order of reception of the corresponding input signal.

4. The system of claim 1, wherein the iterative feedback mixer circuit comprises a buffer storing a predetermined number of prior noise signals.

5. The system of claim 1, wherein the second mixer circuit is further configured to subtract additional symbol-mapped noise representations received from additional mapper circuits corresponding to additional channels from the further input signal.

6. The system of claim 1, further comprising a decoder configured to receive the further input signal after subtraction of the symbol-mapped noise representation, decode the signal, and provide the decoded output to a processor.

7. A system for receive-side distortion cancellation in orthogonal frequency division multiplexing (OFDM), comprising:
a plurality of distortion cancellation circuits, each associated with a channel of a plurality of channels of a received OFDM signal;
wherein each distortion cancellation circuit of the plurality of distortion cancellation circuits is configured to subtract, from an input signal of a corresponding channel, a plurality of noise representations generated by the plurality of distortion cancellation circuits, each noise representation iteratively generated as a weighted sum of a plurality of noise signals of a single channel of the plurality of channels.

8. The system of claim 7, wherein each distortion cancellation circuit comprises a nonlinear distortion generator configured to generate one of the plurality of noise signals.

9. The system of claim 8, wherein each nonlinear distortion generator is configured to calculate a Fourier transform of a difference between an inverse Fourier transform of a decoded input signal and an amplified version of the inverse Fourier transform of the decoded input signal to generate the noise signal.

10. The system of claim 7, wherein each distortion cancellation circuit comprises an OFDM symbol mapper configured to map the noise representation to OFDM symbols, and provide the mapped noise representation to each other distortion cancellation circuit.

11. The system of claim 7, wherein each distortion cancellation circuit comprises a buffer storing a predetermined plurality of previously generated noise signals.

12. The system of claim 11, wherein each distortion cancellation circuit comprises a mixer configured to add each of the predetermined plurality of previously generated noise signals multiplied by a weighting coefficient.

13. The system of claim 12, wherein the weighting coefficient is inversely proportional to an order of generation of the corresponding noise signal.

14. A method for receive-side distortion cancellation in orthogonal frequency division multiplexing (OFDM), comprising:
receiving, by a nonlinear distortion generator, a plurality of demapped and decoded input signals received via a first channel;
generating, by the nonlinear distortion generator, a corresponding plurality of noise signals;
generating, by an iterative feedback mixer circuit, an output distortion signal comprising a weighted sum of the plurality of noise signals;
mapping, by an OFDM mapper circuit, the output distortion signal to OFDM symbols to generate a symbol-mapped noise representation; and
subtracting, by a second mixer circuit, the symbol-mapped noise representation from a further input signal.

15. The method of claim 14, wherein generating the plurality of noise signals further comprises, for each input signal, calculating an inverse Fourier transform of said input signal to generate an intermediate signal.

16. The method of claim 15, wherein generating the plurality of noise signals further comprises, for each input signal, calculating a Fourier transform of a difference of the intermediate signal and an amplified version of the intermediate signal to generate a noise signal.

17. The method of claim 14, wherein the weighted sum comprises a sum of a predetermined number of noise signals, each of the noise signals multiplied by a coefficient inversely proportional to an order of reception of the corresponding input signal.

18. The method of claim 14, further comprising storing, by a buffer of the iterative feedback mixer circuit, a predetermined number of prior noise signals.

19. The method of claim 14, further comprising subtracting, by the second mixer circuit, additional symbol-mapped noise representations received from additional mapper circuits corresponding to additional channels from the further input signal.

20. The method of claim 14, further comprising decoding, by a decoder, the further input signal after subtraction of the symbol-mapped noise representation, and providing the decoded output to a processor.
